(19) United States
(12) Patent Application Publication
(10) Pub. No.: US 2020/0036033 A1
(43) Pub. Date: Jan. 30, 2020

(54) ALUMINUM-ION BATTERY ASSEMBLY

(71) Applicant: AB Systems, Inc., Palo Alto, CA (US)

(72) Inventors: Meng-Chang LIN, Palo Alto, CA (US); Meijie TANG, Palo Alto, CA (US); Chun-Jern PAN, Palo Alto, CA (US); Pengfei Ql, Palo Alto, CA (US)

(21) Appl. No.: 16/459,449

(22) Filed: Jul. 1, 2019

Related U.S. Application Data
(60) Provisional application No. 62/693,210, filed on Jul. 2, 2018.

(51) Int. Cl. H01M 10/054; H01M 10/04; H01M 10/44; H01M 10/0568; H01M 2/02; H01M 4/587; H01M 4/38

(52) U.S. Cl. CPC H01M 10/054; H01M 10/0468; H01M 10/446; H01M 2300/0025; H01M 2/0275; H01M 4/587; H01M 4/38; H01M 10/0568

(57) ABSTRACT

A battery assembly is described that comprises at least one battery cell; an inner container; a compression apparatus for sealing the inner container; and an outer container containing the inner container and the compression apparatus.

### CROSS-REFERENCE TO RELATED APPLICATIONS

This application claims the benefit of priority to U.S. Provisional Patent Application No. 62/693,210, filed Jul. 2, 2018, the entire contends of which are herein incorporated by reference in its entirety for all purposes.

### FIELD

The present disclosure concerns rechargeable (i.e., secondary) batteries as well as methods of making and using the same. In some examples, the present disclosure concerns rechargeable batteries such as, but not limited to, rechargeable batteries having an aluminum (Al) metal anode (i.e., negative electrode).

### BACKGROUND

A battery's energy density is related to the electrochemical potential difference for an atom in the anode relative to the corresponding ion in the cathode. The electrochemical potential for a metal atom in a metal made of identical atoms is 0 V. Metal anodes as compared to intercalation anodes (e.g., Li₆C or lithium titanate) maximize the energy difference between the anode and any cathode. Therefore, to increase the energy density of current batteries, as well as for safety and economic reasons, metal anode rechargeable batteries are desired but not yet commercially available.

Aluminum (Al) is an attractive metal for a metal anode rechargeable battery. The three-electron redox properties of Al provides a theoretical gravimetric capacity as high as 2,980 mAh/g and a volumetric capacity as high as 804 Ah cm⁻³, when paired with a carbon-containing cathode. Al is also the third most abundant element in the Earth's crust. Al is generally less reactive than other metal anodes (e.g., lithium (Li) and sodium (Na)) and is easier to process. Al is therefore an economically viable choice for large scale battery manufacturing and, for example, grid storage applications.

Key to commercializing Al-metal anode rechargeable batteries is the development of electrolytes which are chemically compatible with Al and which are sufficiently ionically conductive. Also critical is the development of packaging materials which can enclose an Al-metal anode rechargeable battery and its electrolyte without corroding the battery and degrading electrochemical performance. Some researchers have developed Al-metal anode rechargeable batteries and used electrolytes which included ionic liquid electrolyte (ILE) mixtures of AlCl₃ and 1-ethyl-3-methylimidazolium chloride ([EMIm]Cl) or AlCl₃ and urea. See, for example, US Patent Application Publication No. 2015-0249261; Lin, M-C, et al., Nature, 2015, p. 1-16, doi:1038/nature143040; and Angell, et al., PNAS, Early Edition, 2016, p. 1-6, doi:10.1073/pnas.1619795114, the entire contents of each of which are herein incorporated by reference in their entirety for all purposes.

Previously prepared Al-metal batteries suffer from a variety of disadvantages including instability during use and instability over the total operation time of the battery. In prior publications, Al-metal batteries were cycled, and, if they remained stable, for example, they only remained stable for up to 100 hours of operation time, e.g., cycled at 70C rate for 7000 cycles. What is needed, for example is batteries that can be cycled and remain stable at 1C rate for 7000 cycles, which would include 7000 hours of operation time. Some of the prior-published Al-metal batteries showed capacity and/or coulombic efficiency fade after a few electrochemical charge-discharge cycles. One unresolved problem relates to the lack of chemically compatible materials which can be used to enclose an Al-metal anode rechargeable battery. Such materials need to be chemically compatible with the acidic environment of the chloride-containing electrolytes used with Al-metal anode rechargeable battery and also sufficiently strong to contain the battery components. Another problem relates to the hygroscopic nature of ionic liquid electrolytes. Trace amounts of water in these electrolytes are difficult to remove and can form by-products, such as hydrochloric acid (HCl), hydrogen gas (H₂) and carbon dioxide (CO₂). If these by-products are sealed in the battery, they can result in corrosion, deformation, or destruction of the battery or its packaging.

In view of these as well as other unmet challenges, there exists a need for improved metal anode rechargeable batteries, including Al-metal anode rechargeable batteries.

### SUMMARY

In one embodiment, set forth herein is a battery assembly including at least one battery cell; an inner container; a compression apparatus for compressing the inner container; and an outer container containing the inner container and the compression apparatus; wherein: the battery cell comprises a negative electrode, a positive electrode, and a non-aqueous electrolyte; the inner container contains the non-aqueous electrolyte and the at least one battery cell; the compression apparatus comprises: a top soft plate and a bottom soft plate positioned on opposite sides of the inner container; a top hard plate and a bottom hard plate positioned on opposite sides of the inner container; wherein the top soft plate is between the top hard plate and the inner container; and wherein the bottom soft plate is between the bottom hard plate and the inner container; and the outer container comprises an outlet and a seal at the outlet, wherein the seal is configured to allow removal of gas from within the outer container.

In a second embodiment, set forth herein is a process for assembling a battery, the process including placing a battery cell and an electrolyte through an opening of and into an inner container; vacuum sealing the opening after the battery cell and the electrolyte are placed into the inner container; after sealing of the opening, cycling the battery; optionally after or while cycling the battery, removing the gas from within the inner container; placing the sealed inner container inside an outer container; sealing the outer container; and creating a vacuum or inert environment in the outer container while the inner container is encased inside the outer container.

In a third embodiment, set forth herein is a process for assembling a battery, the process including placing a battery cell and an electrolyte into an inner container; vacuum sealing the inner container after the battery cell and the electrolyte are placed into the inner container to form a sealed inner container; placing a second battery cell and a second electrolyte into a second inner container; vacuum sealing the opening after the second battery cell and the second electrolyte are placed into the second inner container to form a second sealed inner container; placing the sealed inner container and sealed second inner container inside an outer container; sealing the outer container; and creating a vacuum or inert environment in the outer container while the inner container is encased inside the outer container, the vacuum, when present, forming a pressure gradient between a region outside of the inner container and a region inside of the inner container.

In a fourth embodiment, set forth herein is a process for assembling a battery, the process including placing a battery cell and an electrolyte into an inner container; vacuum sealing the inner container after the battery cell and the electrolyte are placed into the inner container to form a sealed inner container; after sealing of the inner container, cycling the battery cell; optionally after or while cycling the battery, removing the gas from within the inner container; cutting and shortening the inner container to form a cut and shortened inner container; vacuum sealing the cut and shortened inner container; placing the sealed, cut and shortened inner container inside an outer container; sealing the outer container; and creating a vacuum or inert environment in the outer container while the inner container is encased inside the outer container, the vacuum, when present, forming a pressure gradient between a region outside of the inner container and a region inside of the inner container.

In a fifth embodiment, set forth herein is a method for conditioning a battery, the method including providing a battery assembly described herein; forming a negative pressure gradient across a wall of the inner container, and removing a gas from a region within the battery assembly, the region disposed between the inner container and the outer container, and wherein, in some examples, the pressure inside the outer container is less than the pressure outside of the outer container.

### BRIEF DESCRIPTIONS OF THE DRAWINGS

FIG. 1 shows an optical image for an inner container suitable for use in a battery assembly described herein.

FIG. 2 shows an optical image for an inner container and compression apparatus suitable for use in a battery assembly described herein.

FIG. 3 a schematic cross section, viewed end-on, for an Al-ion battery assembly.

FIG. 4 shows filling of electrolyte in an inner container.

FIG. 5 shows encapsulation in an outer container.

FIG. 6 shows a schematic for an example battery assembly process described herein.

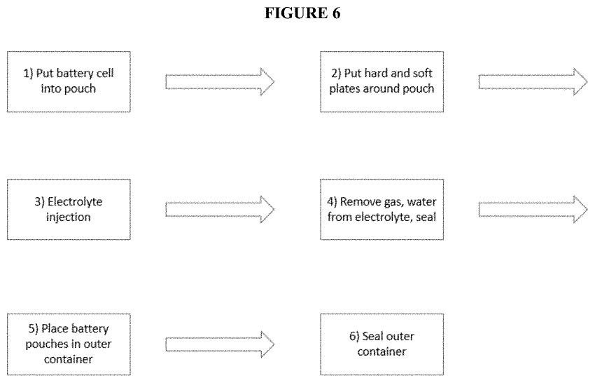

FIG. 7 shows a battery's cycle-life performance with an FEP pouch as an inner container as a plot of specific capacity (left y-axis; mAh/g) as a function of cycle number (x-axis) overlaid with a plot of coulombic efficiency (right y-axis, CE) as a function of cycle number (x-axis).

FIG. 8 shows a battery's cycle-life performance with an FEP pouch further comprising a polyimide layer as an inner container as a plot of specific capacity (left y-axis; mAh/g) as a function of cycle number (x-axis) overlaid with a plot of coulombic efficiency (right y-axis, CE) as a function of cycle number (x-axis).

FIG. 9 shows a battery's cycle-life performance with an inner container with an FEP layer facing the electrolyte and a polyimide facing the outer container, and an aluminum can as an outer container as a plot of specific capacity (left y-axis; mAh/g) as a function of cycle number (x-axis) overlaid with a plot of coulombic efficiency (right y-axis, CE) as a function of cycle number (x-axis).

### DETAILED DESCRIPTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the inventions herein are not intended to be limited to the embodiments presented, but are to be accorded their widest scope consistent with the principles and novel features disclosed herein.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### General

Set forth herein are materials and methods for making and using long-cycle life batteries having ionic liquid (IL) and ionic liquid analogue (ILA) electrolytes. In some examples, the batteries herein include chemically resistant pouches or containers made of fluorinated materials, such as fluorinated ethylene propylene (FEP) and polytetrafluoroethylene (PTFE). These fluorinated materials are useful for preventing corrosion of the pouch or container by the IL or ILA electrolyte filled inside. Also set forth herein are methods and devices for removing trace amounts of water and electrochemical cycling by-products from a battery. In some examples, set forth herein is a vacuum tube mounted onto a pouch or container which includes a material chemically compatible with the battery components. After sealing and/or placing battery cell inside such a pouch or container, set forth herein are methods of vacuum-pumping the electrolyte in the battery cell through the vacuum tube while charging and discharging the battery cell it for 30-60 cycles or more. These methods remove residual water, side-reaction products and sources of hydrogen that could react with an electrolyte to form hydrochloric acid and hydrogen gas during use. After vacuum-pumping while cycling for 30-60 cycles or more, set forth herein are methods of sealing the battery pouch or container to provide a highly stable Al-metal anode batteries with a long cycle life. In some examples, this includes sealing the vacuum tube or the port in the pouch or container through which the vacuum tube is positioned. In many examples herein, the cycle life stability, when considered for the operation time of the battery, is greater than 2000 cycles at 1C rate and tens of thousands cycles at faster rate. Also set forth herein are high purity (e.g., greater than 99.9% pure) metal substrates suitable as current collectors. These substrates include Nickel (Ni) foil and Tungsten (W) foil, as well as high purity metal meshes, such as Ni mesh and W mesh.

In some methods herein, the battery cells are subjected to vacuum-pumping during charge-discharge cycles for the 30-60 cycles or more to remove any volatile side reaction products including any source of hydrogen containing species which could react with the electrolyte to form HCl or H₂ gas. In these methods, the cycling is typically accomplished with 2.4 V charge cut-off voltage at room temperature or with 2.6 V charge cut-off voltage when conducted at −20° C. In some of these methods, the cycling is accomplished with both a 2.4 V and a 2.6 V charge cut-off voltage. After this vacuum-pumping, some of these battery cells are sealed under vacuum and do not require additional vacuum-pumping. In some examples, the batteries herein have a cycle life of thousands of cycles when cycled at about 1 C-rate and tens of thousands of cycles when cycled at 5 to 60 C-rate. In some of these examples, the metal current collectors used with the graphite-including cathode included Nickel (Ni) foil and Tungsten (W) foil, Ni mesh and W mesh. The metals are in some examples more than 99.9% pure.

### Definitions

As used herein, the singular terms “a,” “an,” and “the” include plural referents unless the context clearly dictates otherwise. Thus, for example, reference to an object can include multiple objects unless the context clearly dictates otherwise.

As used herein, the term “about,” when qualifying a number, e.g., 100° C., refers to the number qualified and optionally the numbers included in a range about that qualified number that includes ±10% of the number. For example, about 100° C. includes 100° C. as well as 90° C., 91° C., 92° C., 93° C., 94° C., 95° C., 96° C., 97° C., 98° C., 99° C., 100° C., 101° C., 102° C., 103° C., 104° C., 105° C., 106° C., 107° C., 108° C., 109° C., and 110° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrases “electrochemical cell” or “battery cell” shall mean a single cell including an anode and a cathode, which have ionic communication between the two using an electrolyte.

As used herein, the terms “cathode” and “anode” refer to the electrodes of a battery. In some instances, the anode of an Al-metal anode battery includes Al. In some instances, the cathode includes graphite. During charging, AlCl₄⁻ ions de-intercalate from the graphite and conduct through the electrolyte to eventually plate out Al at the anode. During discharging, Al₂Cl₇⁻ ions dissolve from the Al anode, convert into AlCl₄⁻ ions while conducting through the electrolyte and eventually intercalate in the graphite in the cathode. During a charge cycle, electrons leave the cathode and move through an external circuit to the anode. During a discharge cycle, electrons leave the anode and move through an external circuit to the cathode. Unless otherwise specified, the cathode refers to the positive electrode. Unless otherwise specified, the anode refers to the negative electrode.

As used here, the phrase “direct contact,” refers to the juxtaposition of two materials such that the two materials contact each other sufficiently to conduct either an ion or electron current. As used herein, direct contact refers to two materials in contact with each other and which do not have any materials positioned therebetween.

As used herein, the term “separator,” refers to the physical barrier which electrically insulates the anode and the cathode from each other. The separator is often porous so it can be filled or infiltrated with an electrolyte. The separator is often mechanically robust so it can withstand the pressure applied to the electrochemical cell. Example separators include, but are not limited to, SiO₂ glass fiber separators or SiO₂ glass fiber mixed with a polymer fiber or mixed with a binder.

As used herein, the term “ionic liquid electrolyte” or “ILE,” refers to nonflammable electrolytes which include a mixture of a strong Lewis acid metal halide and Lewis base ligand. Examples include, but are not limited to, AlCl₃ and 1-ethyl-3-methylimidazolium chloride ([EMIm]Cl). Example Lewis base ligands include, but are not limited to, urea, acetamide, or 4-propylpyridine. In a typical ILE having AlCl₃ as a metal halide, AlCl₃ undergoes asymmetric cleavage to form a tetrachloroaluminate anion (AlCl₄⁻) and an aluminum chloride cation (AlCl₂⁺) in which a ligand is datively bonded to (or associated through coordination via sharing of lone pair electrons) the AlCl₂⁺ cation, forming ([AlCl₂.n(ligand)]⁺). Ionic liquids are useful as electrolytes for Al-metal anode batteries. Examples include AlCl₃ and 1-ethyl-3-methylimidazolium chloride (EMIC), AlCl₃ and urea, AlCl₃ and acetamide, AlCl₃ and 4-propylpyridine, and AlCl₃ and trimethylphenylammonium chloride.

As used herein, the term “deep eutectic solvent,” “deep eutectic solvent electrolyte,” or “DES,” refers to a mixture of a strong Lewis acid metal halide and a Lewis base ligand. See, for example, Hogg, J M, et al., Green Chem 17(3):1831-1841; Fang, Y, et al., Electrochim Act 160:82-88; Fang, Y, et al., Chem. Commun. 51(68)13286-13289; and also Pulletikurthi, G., et al., Nature, 520(7547):325-328 for a non-limiting set of example DES mixtures. The content of each of these references in herein incorporated by reference in its entirety for all purposes. Examples include, but are not limited to, AlCl₃ and urea.

As used herein, a “chemically compatible enclosure,” refers to an enclosure which physically contains an anode, cathode, separator and electrolyte without resulting in a substantial amount of corrosion. Inner containers (e.g., fluorinated polymers, or fluorinated polymers further layered with non-fluorinated polymers, e.g., polyimides) as described herein comprise substantially chemically compatible enclosures. A substantial amount of corrosion includes an amount which degrades the coulombic efficiency of a battery by more than 10% or which reduces its capacity by more than 10%. Chemical compatibility is considered with respect to the reactivity of a material and an ILE or DES. A material which reacts with an ILE or DES, e.g., polypropylene, and degrades the coulombic efficiency of a battery by more than 10% or which reduces its capacity by more than 10%, is not chemically compatible, as the phrase is used herein. Chemically compatible enclosures herein do not include Swage-log battery cells, plastic pouches or sealed glass battery cells. A non-limiting example of a chemically compatible enclosure is a FEP pouch surrounding a cathode, anode and ILE or DES. In some instances, the FEP pouch further contacts a polyimide layer. And inside the FEP pouch, in some examples, is the cathode, anode, and ILE (or DES).

As used herein, “sealable port for a liquid or gas,” refers to a port, a tube, a hole, a conduit, a channel, a seam, or the like which can be included with an enclosure to provide for the transfer of liquids or gases into or out of the enclosure. The sealable port for a liquid or gas extends through or traverses the enclosure but forms a seal with the enclosure at the points through which it extends through or traverses the enclosure. The sealable port for a liquid or gas is capable of being sealed after it has been used for the transfer of liquids or gases into or out of the enclosure. For example, a tube can extend through an enclosure which encloses a battery. The tube, once sealed, in combination with the enclosure seals the battery and protects it from exposure to ambient conditions. Before the tube is sealed, the tube can be used to vacuum-pump gases out of the battery. Once the gases are vacuum-pumped out of the battery, the tube can be sealed, either reversibly or permanently.

As used herein, the term “metal halide salt,” refers to a salt which includes at least one metal atom and at least one halogen atom. Examples include, but are not limited to, AlF₃, AlCl₃, AlBr₃, AlI₃, and combinations thereof.

As used herein, the phrase “hydrophilic-treated polymer” refers to fluorinated polymers which are functionalized or modified to include hydrophilic groups on the surface.

As used herein, the term “cycling,” refers to an electrochemical process whereby an electrochemical cell having an anode and a cathode is charged and discharged.

As used herein, the term “C-rate” refers to a measure of the rate at which a battery is discharged relative to its maximum capacity. A 1C rate means that the discharge current will discharge the entire battery in 1 hour. For a battery with a capacity of 100 Amp-hrs, a 1C rate equates to a discharge current of 100 Amps.

### Chemistry

Typically, an electrochemical cell includes, in some examples, an Al anode and a graphite-including cathode. During a discharging reaction, Al reacts at the anode interface to form Al₂Cl₇⁻ ions which are solvated by an ionic liquid and react to form AlCl₄⁻. During a discharge, electrons conduct by way of an external circuit from the anode to the cathode. Also, during discharging, AlCl₄⁻ intercalates into graphite as carbon is oxidized. In this example, the ionic liquid is illustrated as AlCl₃-1-ethyl-3-methylimidazolium chloride ([EMIm]Cl). During charging, the Al₂Cl₇⁻ is reduced to deposit Al metal at the anode interface. During a charge, electrons conduct by way of an external circuit from cathode to the anode. In some of the examples, herein, the mole ratio of AlCl₃:[EMIm]Cl is about 1.3:1, 1.4:1, 1.5:1, 1.6:1, 1.7:1, 1.8:1, or 1.9:1 unless specified otherwise.

Ionic liquid electrolytes can be formed by slowly mixing or otherwise combining an aluminum halide (e.g., AlCl₃) and an organic compound. In certain examples, the aluminum halide undergoes asymmetric cleavage to form a haloaluminate anion (e.g., AlCl₄⁻) and an aluminum halide cation that is datively bonded to the organic compound serving as a ligand (e.g., [AlCl₂.n(ligand)]⁺). A mole ratio of the aluminum halide and the organic compound can be at least or greater than about 1.1 or at least or greater than about 1.2, and is up to about 1.5, up to about 1.8, up to about 2, or more. For example, the mole ratio of the aluminum halide and the organic compound (e.g., urea) can be in a range of about 1.1 to about 1.7 or about 1.3 to about 1.5. In some embodiments, a ligand is provided as a salt or other compound including the ligand, and a mole ratio of the aluminum halide and the ligand-containing compound can be at least or greater than about 1.1 or at least or greater than about 1.2, and is up to about 1.5, up to about 1.8, up to about 2, or more. An ionic liquid electrolyte can be doped, or have additives added, to increase its electrical conductivity and lower the viscosity, or can be otherwise altered to yield compositions that favor the reversible electrodeposition of metals. For example, 1,2-dichlorobenzene can be added as a co-solvent to reduce electrolyte viscosity and increase the voltage efficiency, which can result in an even higher energy density. Also, alkali chloride additives can be added to increase the discharge voltage of a battery. In some examples, 1-ethyl-3-methylimidazolium tetrafluoroborate or 1-ethyl-3-methylimidazolium bis(trifluoromethane sulfonimide) or 1-ethyl-3-methylimidazolium hexafluorophosphate can be added as additives to increase the discharge voltage of a battery.

Other ionic liquid electrolytes are suitable for use with an Al-metal anode battery. For example, AlCl₃:Urea can be used as an ionic liquid electrolyte. In certain examples, Aluminum deposition proceeds through two pathways, one involving Al₂Cl₇⁻ anions and the other involving [AlCl₂.(urea)n]+cations. The following simplified half-cell redox reactions describe this process:

2[AlCl₂.n(urea)]³⁰ +3e^{-→Al+AlCl}₄⁻+2n(urea)

Cₙ(AlCl₄⁻)+e⁻→Cₙ+AlCl₄⁻

which gives an overall battery reaction (including counter ions):

2([AlCl₂.n(urea)]⁺AlCl₄⁻)+3Cₙ→Al+3CₙAlCl₄+2n(urea).

### Batteries

In some examples, set forth herein is a battery assembly comprising: at least one battery cell; an inner container; a sealing apparatus for sealing the inner container; and an outer container containing the inner container and the sealing apparatus; wherein: the battery cell comprises a negative electrode, a positive electrode, and a non-aqueous electrolyte; the inner container contains the non-aqueous electrolyte and the at least one battery cell; the sealing apparatus comprises: a top soft plate and a bottom soft plate positioned on opposite sides of the inner container; a top hard plate and a bottom hard plate positioned on opposite sides of the inner container; wherein the top soft plate is between the top hard plate and the inner container; and wherein the bottom soft plate is between the bottom hard plate and the inner container; and the outer container comprises an outlet and a seal at the outlet, wherein the seal is configured to allow removal of gas from within the outer container.

In some examples, including any of the foregoing, the battery assembly includes means for compressing the top soft plate, bottom soft plate, top hard plate, and bottom hard plate. The means for compressing may include a screw and nut assembly, a clamp, or an equivalent thereof.

In some examples, including any of the foregoing, the sealing apparatus compresses the inner container and thereby prevents the seal of the inner container from opening.

In some examples, including any of the foregoing, the sealing apparatus is a compression apparatus.

In some examples, the at least one battery cell in the battery assembly includes a metal anode, a cathode, a separator between the metal anode and the cathode, an ionic liquid electrolyte (ILE) or deep eutectic solvent electrolyte (DES) in direct contact with the metal anode, the cathode, and the separator, and an inner container, which is a chemically compatible enclosure, in direct contact with the ILE or DES and encapsulating the metal anode, the cathode, the separator, and the ILE or DES. In the battery cell, the ILE or DES includes a metal halide salt and an organic compound. In some examples, the ILE or DES includes a mixture of a metal halide salt and an organic compound. The battery assembly comprises a sealing apparatus for sealing the inner container, and an outer container containing the inner container and the sealing apparatus. In some examples, more than one battery cell is included in the battery assembly and the battery assembly includes a plurality of inner containers within the outer container.

In an example, the outer container comprises a negative terminal electrically connected to a current collector tab which is electrically connected to a negative electrode, and the outer container comprises a positive terminal electrically connected to a current collector tab which is electrically connected to a positive electrode.

In some instances, the inner container is chemically compatible with the non-aqueous electrolyte, i.e., it does not react with the non-aqueous electrolyte. In such instances, the non-aqueous electrolyte is selected from an ionic liquid electrolyte (ILE) or a deep eutectic solvent electrolyte (DES).

In certain examples, the inner container, which contains the non-aqueous electrolyte, comprises a fluorinated polymer. In one example, an inner container is prepared by heat sealing (e.g., with an impulse sealer, a hot air sealer or a band sealer), a top layer or sheet of a fluorinated polymer and a bottom layer or sheet of fluorinated polymer on three edges to form a pouch therebetween into which the electrolyte is placed. In this example, the inner container is a single layer fluorinated polymer container. In some instances, an inner container is prepared by heat sealing multiple (e.g., two or more) top layers/sheets of a fluorinated polymer and multiple (e.g., two or more) bottom layers/sheets of a fluorinated polymer. In such instances, an inner container is a multi-layer container.

In some examples, including any of the foregoing, the fluorinated polymer protects the metal anode, the cathode, and the ionic liquid electrolyte from exposure to ambient conditions. In some examples, including any of the foregoing, the fluorinated polymer is free of corrosion from the ILE or DES. In some examples, including any of the foregoing, the fluorinated polymer does not react with the ILE or DES. In some examples, including any of the foregoing, the fluorinated polymer has a thickness of about 1 μm-1000 μm. In some examples, including any of the foregoing, the fluorinated polymer has a thickness of about 1 mm-100 mm. In some examples, including any of the foregoing, the fluorinated polymer has a thickness of about 1 mm-1,000 mm.

In some examples, including any of the foregoing, the fluorinated polymer is selected from fluorinated ethylene propylene (FEP), polytetrafluoroethylene (PTFE), polyvinylidene fluoride (PVDF), hexafluoropropylene (HFP), and combinations thereof. In some examples, the fluorinated polymer is FEP. In some examples, the fluorinated polymer is PTFE. In some examples, the fluorinated polymer is PVDF. In some examples, the fluorinated polymer is HFP. In some examples, the fluorinated polymer is PVDF-HFP.

In some examples, the total width of the inner container is about 50 μm to about 200 μm. In some examples, the total width of the inner container is about 50 μm. In some examples, the total width of the inner container is about 60 μm. In some examples, the total width of the inner container is about 70 μm. In some examples, the total width of the inner container is about 80 μm. In some examples, the total width of the inner container is about 90 μm. In some examples, the total width of the inner container is about 100 μm. In some examples, the total width of the inner container is about 110 μm. In some examples, the total width of the inner container is about 120 μm. In some examples, the total width of the inner container is about 130 μm. In some examples, the total width of the inner container is about 140 μm. In some examples, the total width of the inner container is about 150 μm. In some examples, the total width of the inner container is about 160 μm. In some examples, the total width of the inner container is about 170 μm. In some examples, the total width of the inner container is about 180 μm. In some examples, the total width of the inner container is about 190 μm. In some examples, the total width of the inner container is about 200 μm. In some of these examples, the thickness of the fluorinated polymer layer is 70-150 μm. In some of these examples, the thickness of the aluminum layer is 70-150 μm.

In some examples, including any of the foregoing, the fluorinated polymer of the inner container has a thickness of about 50 μm-250 μm. In certain examples, the fluorinated polymer of the inner container has a thickness of about 50 μm. In certain examples, the fluorinated polymer of the inner container has a thickness of about 60 μm. In certain examples, the fluorinated polymer of the inner container has a thickness of about 70 μm. In certain examples, the fluorinated polymer of the inner container has a thickness of about 80 μm. In certain examples, the fluorinated polymer of the inner container has a thickness of about 90 μm. In certain examples, the fluorinated polymer of the inner container has a thickness of about 100 μm. In certain examples, the fluorinated polymer of the inner container has a thickness of about 110 μm. In certain examples, the fluorinated polymer of the inner container has a thickness of about 120 μm. In certain examples, the fluorinated polymer of the inner container has a thickness of about 130 μm. In certain examples, the fluorinated polymer of the inner container has a thickness of about 140 μm. In certain examples, the fluorinated polymer of the inner container has a thickness of about 150 μm. In certain examples, the fluorinated polymer of the inner container has a thickness of about 160 μm. In certain examples, the fluorinated polymer of the inner container has a thickness of about 170 μm. In certain examples, the fluorinated polymer of the inner container has a thickness of about 180 μm. In certain examples, the fluorinated polymer of the inner container has a thickness of about 190 μm. In certain examples, the fluorinated polymer of the inner container has a thickness of about 50 μm. In certain examples, the fluorinated polymer of the inner container has a thickness of about 200 μm. In certain examples, the fluorinated polymer of the inner container has a thickness of about 210 μm. In certain examples, the fluorinated polymer of the inner container has a thickness of about 220 μm. In certain examples, the fluorinated polymer of the inner container has a thickness of about 230 μm. In certain examples, the fluorinated polymer of the inner container has a thickness of about 240 μm. In certain examples, the fluorinated polymer of the inner container has a thickness of about 250μm.

In some examples, the total width of the inner container is about 1 mm to about 200 mm. In some examples, the total width of the inner container is about 1 mm. In some examples, the total width of the inner container is about 5 mm. In some examples, the total width of the inner container is about 10 mm. In some examples, the total width of the inner container is about 20 mm. In some examples, the total width of the inner container is about 30 mm. In some examples, the total width of the inner container is about 40 mm. In some examples, the total width of the inner container is about 50 mm. In some examples, the total width of the inner container is about 60 mm. In some examples, the total width of the inner container is about 70 mm. In some examples, the total width of the inner container is about 80 mm. In some examples, the total width of the inner container is about 90 mm. In some examples, the total width of the inner container is about 100 mm. In some examples, the total width of the inner container is about 110 mm. In some examples, the total width of the inner container is about 120 mm. In some examples, the total width of the inner container is about 130 mm. In some examples, the total width of the inner container is about 140 mm. In some examples, the total width of the inner container is about 150 mm. In some examples, the total width of the inner container is about 160 mm. In some examples, the total width of the inner container is about 170 mm. In some examples, the total width of the inner container is about 180 mm. In some examples, the total width of the inner container is about 190 mm. In some examples, the total width of the inner container is about 200 mm. In some of these examples, the thickness of the fluorinated polymer layer is 1 mm-50 mm. In some of these examples, the thickness of the aluminum layer is 1 mm-50 mm.

In some examples, the fluorinated polymer of the inner container is about 1 mm to about 200 mm. In some examples, the fluorinated polymer of the inner container is about 1 mm. In some examples, the fluorinated polymer of the inner container is about 5 mm. In some examples, the fluorinated polymer of the inner container is about 10 mm. In some examples, the fluorinated polymer of the inner container is about 20 mm. In some examples, the fluorinated polymer of the inner container is about 30 mm. In some examples, the fluorinated polymer of the inner container is about 40 mm. In some examples, the fluorinated polymer of the inner container is about 50 mm. In some examples, the fluorinated polymer of the inner container is about 60 mm. In some examples, the fluorinated polymer of the inner container is about 70 mm. In some examples, the fluorinated polymer of the inner container is about 80 mm. In some examples, the fluorinated polymer of the inner container is about 90 mm. In some examples, the fluorinated polymer of the inner container is about 100 mm. In some examples, the fluorinated polymer of the inner container is about 110 mm. In some examples, the fluorinated polymer of the inner container is about 120 mm. In some examples, the fluorinated polymer of the inner container is about 130 mm. In some examples, the fluorinated polymer of the inner container is about 140 mm. In some examples, the fluorinated polymer of the inner container is about 150 mm. In some examples, the fluorinated polymer of the inner container is about 160 mm. In some examples, the fluorinated polymer of the inner container is about 170 mm. In some examples, the fluorinated polymer of the inner container is about 180 mm. In some examples, the fluorinated polymer of the inner container is about 190 mm. In some examples, the fluorinated polymer of the inner container is about 200 mm. In some of these examples, the thickness of the fluorinated polymer layer is 1 mm-50 mm. In some of these examples, the thickness of the aluminum layer is 1 mm-50 mm.

In some examples including any of the foregoing, the thickness of the inner container or the outer container is measured using a Vernier calipers, a spiral micrometer or a thin film analyzer.

In some examples, including any of the foregoing, the fluorinated polymer of the inner container includes a single layer. In some examples, including any of the foregoing, the fluorinated polymer of the inner container includes multiple layers, e.g., one or more layers/films/sheets of polymer are used to form a pouch/inner container. In some examples, including any of the foregoing, the fluorinated polymer of the inner container is a bi-layer. In some examples, including any of the foregoing, the fluorinated polymer of the inner container is a tri-layer. In some examples, including any of the foregoing, the fluorinated polymer of the inner container is a combination of four layers of the fluorinated polymer. In some examples, including any of the foregoing, the fluorinated polymer of the inner container is a combination of five layers of the fluorinated polymer. In some examples, including any of the foregoing, the fluorinated polymer of the inner container is a combination of four layers of the fluorinated polymer. In some examples, including any of the foregoing, the fluorinated polymer of the inner container is a combination of six layers of the fluorinated polymer. In some examples, including any of the foregoing, the fluorinated polymer of the inner container is a combination of seven layers of the fluorinated polymer. In some examples, including any of the foregoing, the fluorinated polymer of the inner container is a combination of eight layers of the fluorinated polymer. In some examples, including any of the foregoing, the fluorinated polymer of the inner container is a combination of nine layers of the fluorinated polymer. In some examples, including any of the foregoing, the fluorinated polymer of the inner container is a combination of ten layers of the fluorinated polymer. In some examples, including any of the foregoing, the fluorinated polymer of the inner container is a combination of more than ten layers of the fluorinated polymer. In some examples, including any of the foregoing, the fluorinated polymer of the inner container is a multilayer. In some examples, including any of the foregoing, each layer has thickness of 50 μm-250 μm, including all thickness values within this range. In some examples, including any of the foregoing, the fluorinated polymer of the inner container is a multilayer. In some examples, including any of the foregoing, each layer has thickness of 50 μm-250 μm, including all thickness values within this range and the fluorinated polymer of the inner container has a total thickness of about 1 mm-200 mm, including all thickness values within this range.

In some instances of any of the preceding examples, the inner container further comprises a non-fluorinated polymer layer in contact with the fluorinated polymer. In some examples, the non-fluorinated polymer is selected from polyimide, polyethylene, polypropylene, polystyrene, polyvinyl chloride, synthetic rubber, phenol formaldehyde resin, neoprene, nylon, polyacrylonitrile, PVB, silicone, and any combination thereof. In certain examples the non-fluorinated polymer is polyimide. In some instances of any of the preceding examples, the inner container further comprises a polyimide polymer layer in contact with the fluorinated polymer. In some of such instances, an inner container is prepared by heat sealing a top multilayer comprising layers/sheets of fluorinated polymer and non-fluorinated polymers (e.g., polyimide layer or sheet in contact with a layer/sheet of fluorinated polymer) and a bottom multilayer comprising layers/sheets of fluorinated polymer and non-fluorinated polymers. In certain instances, the inner container further comprises a polyimide polymer layer which directly contacts the fluorinated polymer but does not contact the non-aqueous electrolyte (e.g., when the battery is assembled). In other words, the fluorinated polymer layer is in contact with an outer polyimide polymer layer. In any of such instances, the fluorinated polymer and/or the polyimide polymer layer may comprise more than one layer of polymer (e.g., a plurality of polymer films and/or polymer sheets may be present).

In other instances, the inner container further comprises a polyimide polymer layer which directly contacts the fluorinated polymer but does not contact the non-aqueous electrolyte when the battery is assembled, but the polyimide layer may contact the electrolyte where the electrolyte leaks across the fluorinated polymer into the outer container.

In some instances, the inner container comprises a single layer of a fluorinated polymer and a single layer of a non-fluorinated (e.g., polyimide) polymer. In other instances, the inner container comprises multiple layers of a fluorinated polymer and a single layer of a non-fluorinated (e.g., polyimide) polymer. In further instances, the inner container comprises multiple layers of a fluorinated polymer and a single layer of a non-fluorinated (e.g., polyimide) polymer. In some instances, the inner container comprises multiple layers of a fluorinated polymer and multiple layers of a non-fluorinated (e.g., polyimide) polymer. In some instances, the inner container comprises a 1-10, 1-20, 1-100 layers of a fluorinated polymer and a single layer of a non-fluorinated (e.g., polyimide) polymer. In other instances, the inner container comprises 1-10, 1-20, 1-100 layers of a fluorinated polymer and 1-10, 1-20, 1-100 layers of a non-fluorinated (e.g., polyimide) polymer. In further instances, the inner container comprises a single layer of a fluorinated polymer and 1-10, 1-20, 1-100 layers of a non-fluorinated (e.g., polyimide) polymer.

In some examples, a battery assembly described herein has a current collector tab which is electrically connected to a negative electrode and is partially wrapped with carbon tape. In some other examples, the current collector tab which is electrically connected to a positive electrode is partially wrapped with carbon tape. In some of such instances, the fluorinated polymer contacts the carbon tape that partially wraps the current collector tab which is electrically connected to a negative electrode. In some of such instances, the fluorinated polymer contacts the carbon tape that partially wraps the current collector tab which is electrically connected to a positive electrode. In some of such instances, the carbon tape wrapping resides at the junction of the tabs and the inner container's sealed edge.

In an example, the inner container comprises a fluorinated polymer which contains the non-aqueous electrolyte, and current collector tabs wrapped with carbon tape.

In certain instances, the fluorinated polymer described above is a hydrophilic-treated polymer. In some examples, the hydrophilic-treated polymer is selected from hydrophilic-treated polytetrafluoroethylene (PTFE), hydrophilic-treated polyacrylonitrile (PAN), hydrophilic-treated fluorinated ethylene propylene (FEP), hydrophilic-treated polychlorotrifluoroethylene (PCTFE), hydrophilic-treated polyvinylidene fluoride (PVDF), hydrophilic-treated hexafluoropropylene (HFP), hydrophilic-treated PVDF-HFP, and hydrophilic-treated polyfluoroalkoxy (PFA), and combinations thereof. In some of such embodiments, a “hydrophilic-treated polymer” is prepared by attachment of sulfonic acid groups to, for example, polytetrafluoroethylene by radiation-induced graft polymerization (See, e.g., Sugiyama et al., Reactive Polymers, 21 (1993) 187-191) which disclosure is incorporated herein by reference). Alternatively, hydrophilic agents including amino (NH₂), carboxyl (COOH) and sulfonic acid (SO₃H) groups, as different hydrophilic groups, are synthesized via hydrolytic polycondensation and free radical polymerization, which are then adhered to the surface of PTFE by a physical entanglement method (See, e.g., Wang et al., Journal of Water Process Engineering 8 (2015) 11-18 which disclosure is incorporated herein by reference).

As used herein, the phrase “wherein the ILE or DES does not wet the chemically compatible enclosure,” refers to the interaction between an ILE or DES and the interior surface of the chemically compatible enclosure or inner container. Wetting is determined by a contact angle measurement. In this contact angle measurement, an ILE or DES is deposited onto an interior surface of the chemically compatible enclosure. The ILE or DES wets this interior surface of the chemically compatible enclosure when the contact angle between the interior surface of the chemically compatible enclosure and a line tangent to the surface of the ILE or DES, which is deposited thereupon, is less than or equal to 90°. The ILE or DES does not wet the interior surface of the chemically compatible enclosure when the contact angle between the interior surface of the chemically compatible enclosure and a line tangent to the surface of the ILE or DES is greater than 90°. Hydrophilic surfaces are observed to have low contact angles (less than or equal to 90 degrees) with respect to a solution on the hydrophilic surface. Hydrophobic surfaces are observed to have high contact angles (greater than 90 degrees) with respect to a solution on the hydrophobic surface. Hydrophobic and hydrophilic surfaces may be determined as described in PCT International Application PCT/US2018/026968 filed on Apr. 10, 2018, titled “BATTERY WITH LONG CYCLE LIFE” describes methods of making certain batteries, which disclosure is incorporated herein by reference.

In some examples, the fluorinated polymer described above comprises a fluorinated polymer selected from polytetrafluoroethylene (PTFE), fluorinated ethylene propylene (FEP), polyacrylonitrile (PAN), polychlorotrifluoroethylene (PCTFE), polyvinylidene fluoride (PVDF), hexafluoropropylene (HFP), PVDF-HFP, polyfluoroalkoxy (PFA), and combinations thereof.

In some examples, the fluorinated polymer is polytetrafluoroethylene (PTFE), fluorinated ethylene propylene (FEP), polychlorotrifluoroethylene (PCTFE), polyvinylidene fluoride (PVDF) or polyfluoroalkoxy (PFA).

In some examples, the battery assembly has an inner container that is a fluorinated ethylene propylene polymer pouch. In some examples, the battery assembly has an inner container that is a polytetrafluoroethylene pouch. In some examples, the battery assembly has an inner container that is a polychlorotrifluoroethylene pouch. In some examples, the battery assembly has an inner container that is a polyvinylidene pouch. In some examples, the battery assembly has an inner container that is a polyfluoroalkoxy pouch.

In some examples, the compression apparatus in the battery assembly comprises a soft plate selected from a silicone foam plate or a rubber plate.

In some examples, the compression apparatus in the battery assembly comprises a hard plate selected from a steel plate, an aluminum plate, a nickel plate, or an engineered plastic plate. In some examples, the hard plate in the compression apparatus in the battery assembly comprises metals, e.g., iron, nickel, copper, titanium, aluminum, magnesium, manganese, zinc, tin or their alloys (e.g., steel); plastics e.g., acrylonitrile butadiene styrene (ABS), Nylon 6, Nylon 6-6, polyamides (PA), polybutylene terephthalate (PBT), polycarbonates (PC), polyetheretherketone (PEEK), polyetherketone (PEK), polyethylene terephthalate (PET), polyimides, polyoxymethylene plastic (POM/Acetal), polyphenylene sulfide (PPS), polyphenylene oxide (PPO), polysulphone (PSU), polytetrafluoroethylene (PTFE/Teflon), or a combination thereof. In some examples, the compression apparatus in the battery assembly includes a means for applying compression comprising at least one screw and at least one nut, wherein the at least one screw is positioned through the top hard plate and bottom hard plate. In some of such instances, the means for applying compression comprise four screws and four nuts. Other suitable means for applying compression include and are not limited to clamps, pistons, and springs. In some instances of the battery assembly described herein, the at least one battery cell comprises an aluminum (Al) foil negative electrode, a graphite-coated nickel positive electrode and/or a glass fiber separator. In some of such instances, the battery assembly comprises an Al current collector tab and a Ni current collector tab.

In some examples, the batter assembly described herein comprises at least two battery cells. In some instances, the batter assembly described herein comprises at least three battery cells. In some instances, the battery assembly described herein comprises at least at least one hundred battery cells.

In some instances, the battery cells in a battery assembly described herein are tab welded.

In some examples, the battery cells in a battery assembly described herein are stacked in parallel so that they share either a positive electrode current collector or a negative electrode current collector.

In some instances of the battery assembly described herein, the outer container is an aluminum (Al) container. In some instances of the battery assembly described herein, the outer container is a stainless steel container. In some instances of the battery assembly described herein, the outer container is an engineered plastic container. In some of such examples, the outer container is sealed by laser welding.

In some examples, the at least one battery cell in a battery assembly is a prismatic battery cell. In some examples, the at least one battery cell in a battery assembly is rectangular shaped. In some examples, the at least one battery cell in a battery assembly is square shaped.

In some examples, the nonaqueous electrolyte in the at least one battery cell in a battery assembly is an ionic liquid electrolyte. In other instances, the nonaqueous electrolyte in the at least one battery cell in a battery assembly is a deep eutectic solvent electrolyte.

In some examples, the at least one battery cell comprises a metal negative electrode selected from a lithium metal negative electrode, an aluminum metal negative electrode, a sodium metal negative electrode, a potassium metal negative electrode, a calcium metal negative electrode, a magnesium metal negative electrode, an iron metal negative electrode, and a zinc metal negative electrode. In some instances, the at least one battery cell comprises an aluminum metal negative electrode, the nonaqueous electrolyte comprises AlCl₃, and the inner container is a flexible pouch comprising a fluorinated ethylene propylene polymer. In one example, the said flexible pouch is surrounded by a polyimide layer.

In some examples, the at least one battery cell comprises an aluminum metal negative electrode, the nonaqueous electrolyte comprises AlCl₃, and the inner container is a flexible pouch comprising a polyimide layer.

In some examples of the battery assembly described herein, the inner container comprises a sealable port or outlet for liquids or gases. In some embodiments, the inner container comprises an outlet and a seal at the outlet, wherein the seal is configured to allow removal of gas from within the inner container.

In some examples of the battery assembly described herein, the outer container is configured to prevent water and oxygen in surrounding air from entering the outer container. In some examples of the battery assembly described herein, the outer container is configured to maintain a vacuum in the outer container, and the vacuum forms a negative pressure gradient across a wall of the inner container. In some examples of the battery assembly described herein, the outer container is configured to maintain an inert gas environment in the outer container, and the vacuum forms a negative pressure gradient across a wall of the inner container. In some examples of the battery assembly described herein, the outer container is configured to maintain a vacuum in the outer container, and the vacuum forms a negative pressure gradient across the fluorinated polymer of the inner container. In some examples of the battery assembly described herein, the outer container is configured to maintain an inert gas environment in the outer container, and the vacuum forms a negative pressure gradient across the fluorinated polymer of the inner container. In some examples, the pressure inside the outer container is less than the pressure outside of the outer container. In some examples, the pressure inside the inner container is greater than the pressure outside of the inner container. In some examples, the pressure inside the inner container is greater than the pressure between the inner container and the outer container. A pressure gauge can be used to measure pressure in the inner and/or outer containers prior to sealing.

In some examples of the battery assembly described herein, the battery assembly comprises at least two or more battery cells. In some examples of the battery assembly described herein, the battery assembly comprises stacked Al-graphite cells.

In some examples of the battery assembly described herein, the outer container has less than 100 ppm H₂O inside the outer container. In some examples of the battery assembly described herein, the outer container has less than 10 ppm H₂O inside the outer container. In some examples of the battery assembly described herein, the outer container has less than 1 ppm H₂O inside the outer container. A water sensor may be used to measure the water content in the outer container prior to sealing of the outer container. In some examples of the battery assembly described herein, the outer container has less than 100 ppm O₂ inside the outer container. In some examples of the battery assembly described herein, the at least one battery cell comprises a composite separator, comprising a glass fiber layer; a polymer layer, or a derivative thereof; and optionally a binder.

In some examples of the battery assembly described herein, the at least one battery cell comprises a positive electrode comprising graphite.

In some examples of the battery assembly described herein, the at least one battery cell comprises a composite separator comprising a binder selected from the group consisting of polyacrylate (PA), polyacrylic acid (PAA), polyvinyl alcohol (PVA), cross-linked PAA, cross-linked PVA, PAA-PVA, polyacrylic latex, cellulose, cellulose derivatives, alginate, polyethylene glycol, styrene-butadiene rubber, poly(styrene-co-butadiene), styrene-butadiene rubber, poly(3,4-ethylenedioxythiophene), acrylonitrile copolymer, acrylic latex, and combinations thereof. In some of such examples, the binder is selected from the group consisting of poly-acrylic acid (PAA), poly-vinyl alcohol (PVA), cross-linked PAA, cross-linked PVA, styrene-butadiene latex, acrylonitrile copolymer, and acrylic latex. In some other such examples, the binder is selected from the group consisting of PAA and PVA.

In some examples, including any of the foregoing, the cathode includes a polymer binder and a cathode active material blended with the polymer binder.

In some examples, including any of the foregoing, the polymer binder is a hydrophilic polymer binder. In some examples, the polymer binder is a hydrophobic polymer binder. In some of these examples, the hydrophobic polymer binder is selected from polytetrafluoroethylene (PTFE), polyvinylidene fluoride (PVDF), fluorinated ethylene propylene (FEP), hexafluoropropylene (HFP), PVDF-HFP, and combinations thereof.

In some examples, including any of the foregoing, the polymer binder is a hydrophilic polymer selected from polyacrylic acid (PAA) (with or without various degrees of neutralization), polyvinyl alcohol (PVA), PAA-PVA, polyacrylate, polyacrylic, polyacrylic latex, cellulose and cellulose derivatives (e.g., carboxymethyl cellulose (CMC)), alginate, polyethylene oxide, polyethylene oxide block copolymers, polyethylene glycol, styrene-butadiene rubber, poly(styrene-co-butadiene), conducting polymers (e.g., poly(3,4-ethylenedioxythiophene) (PEDOT) and polystyrene sulfonate (PSS)), ionic liquid polymers or oligomers, as well as combinations of two or more of the foregoing hydrophilic polymers, as well as combinations of one or more of the foregoing polymers with one or more hydrophobic polymers, such as styrene-butadiene rubber.

In some examples of the battery assembly described herein, the at least one battery cell comprises a composite separator comprising a binder selected from LA133™.

In some examples of the battery assembly described herein, the non-aqueous electrolyte comprises 1-ethyl-3-methylimidazolium chloride.

In some examples of the battery assembly described herein, the non-aqueous electrolyte comprises urea.

In some examples of the battery assembly described herein, the non-aqueous electrolyte comprises a mixture of (AlCl₃)+1-ethyl-3-methylimidazolium chloride (EMIC).

In some examples of the battery assembly described herein, the non-aqueous electrolyte comprises a mixture of (AlCl₃)+Urea.

In some examples of the battery assembly described herein, the non-aqueous electrolyte comprises a mixture of (AlCl₃)+Methyl Urea (MUrea).

In some examples of the battery assembly described herein, the non-aqueous electrolyte comprises a mixture of (AlCl₃)+Ethyl Urea (EUrea).

In some examples of the battery assembly described herein, the non-aqueous electrolyte comprises a mixture of (AlCl₃)+triethylamine hydrochloride (Et₃NHCl).

In some examples of the battery assembly described herein, the non-aqueous electrolyte comprises a mixture of AlCl₃ and EMIC wherein the molar ratio of AlCl₃/EMIC is 1.4.

In some examples of the battery assembly described herein, the non-aqueous electrolyte comprises a mixture of AlCl₃ and urea, wherein the molar ratio of AlCl₃/Urea is between 1.1 and 1.7.

In some examples of the battery assembly described herein, the non-aqueous electrolyte comprises a mixture of AlCl₃ and urea, wherein the molar ratio of AlCl₃/Urea is 1.3.

In some examples of the battery assembly described herein, the non-aqueous electrolyte comprises a mixture of AlCl₃ and MUrea, wherein the molar ratio of AlCl₃/MUrea is between 1.1 and 1.7.

In some examples of the battery assembly described herein, the non-aqueous electrolyte comprises a mixture of AlCl₃ and MUrea, wherein the molar ratio of AlCl₃/MUrea is 1.4.

In some examples of the battery assembly described herein, the non-aqueous electrolyte comprises a mixture of AlCl₃ and ethyl urea, wherein the molar ratio of AlCl₃/ethyl urea is between 1.1 and 1.7.

In some examples of the battery assembly described herein, the non-aqueous electrolyte comprises a mixture of AlCl₃ and ethyl urea, wherein the molar ratio of AlCl₃/ethyl urea is 1.4.

In some examples of the battery assembly described herein, the non-aqueous electrolyte comprises a mixture of AlCl₃ and urea, wherein the molar ratio of AlCl₃/Urea is 1.5.

In some examples of the battery assembly described herein, the non-aqueous electrolyte comprises a mixture of AlCl₃ and Et₃NHCl, wherein the molar ratio of AlCl₃/Et₃NHCl is 1.5.

In some examples of the battery assembly described herein, the non-aqueous electrolyte comprises a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof.

In some examples of the battery assembly described herein, the non-aqueous electrolyte comprises a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof, with chloride, tetrafluoroborate, tri-fluoromethanesulfonate, hexafluorophosphate or bis(trifluoromethanesulfonyl)imide anions.

In some examples of the battery assembly described herein, the non-aqueous electrolyte comprises a mixture of a metal halide and an organic compound.

In some examples of the battery assembly described herein, the metal halide is an aluminum halide.

In some examples of the battery assembly described herein, the aluminum halide is AlCl₃, and the organic compound comprises:
(a) cations selected from the group consisting of 1-ethyl-3-methyl imidazolium, N-(n-butyl) pyridinium, benzyltrimethylammonium, 1,2-dimethyl-3-propylimidazolium, trihexyltetradecylphosphonium, and 1-butyl-1-methyl-pyrrolidinium, and
(b) anions selected from the group consisting of chloride, tetrafluoroborate, tri-fluoromethanesulfonate, hexafluorophosphate and bis(trifluoromethanesulfonyl)imide.

In some examples of the battery assembly described herein, the aluminum halide is AlCl₃, and the organic compound is selected from the group consisting of urea, methylurea, ethylurea, 4-propylpyridine, acetamide, N-methylacetamide, N,N-dimethylacetamide, trimethylphenylammonium chloride, 1-ethyl-3-methylimidazolium bis(trifluoromethylsulfonyl)imide, 1-ethyl-3-methylimidazolium tetrafluoroborate, 1-ethyl-3-methylimidazolium hexafluorophosphate and 1-ethyl-3-methylimidazolium chloride.

In some examples of the battery assembly described herein, the aluminum halide is AlCl₃, and the organic compound is 1-ethyl-3-methylimidazolium chloride.

In some examples of the battery assembly described herein, the non-aqueous electrolyte comprises an aluminum halide cation that is datively bonded to the organic compound.

In some examples of the battery assembly described herein, the aluminum halide is AlCl₃, and the organic compound is an amide.

In some examples of the battery assembly described herein, the amide is selected from the group consisting of urea, methylurea, ethylurea, and combinations thereof.

In some examples of the battery assembly described herein, the metal halide is AlCl₃; and the organic compound is selected from the group consisting of 1-ethyl-3-methyl imidazolium chloride, 1-ethyl-3-methylimidazolium bis(trifluoromethylsulfonyl)imide, 1-ethyl-3-methylimidazolium tetrafluoroborate, 1-ethyl-3-methylimidazolium hexafluorophosphate, urea, methylurea, ethylurea, mixtures thereof, and combinations thereof.

In some examples of the battery assembly described herein, the non-aqueous electrolyte comprises a mixture of AlCl₃ and 1-ethyl-3-methyl imidazolium chloride, wherein the mole ratio of AlCl₃:1-ethyl-3-methyl imidazolium chloride is from 1.1 to 1.7.

In some examples of the battery assembly described herein, the non-aqueous electrolyte comprises a mixture of a mixture of 1.1 to 1.7 moles AlCl₃, 1.0 mole 1-ethyl-3-methyl imidazolium chloride and 0.1 to 0.5 mole 1-ethyl-3-methylimidazolium bis(trifluoromethylsulfonyl)imide or 1-ethyl-3-methylimidazolium tetrafluoroborate or 1-ethyl-3-methylimidazolium hexafluorophosphate.

In some examples, including any of the foregoing, the metal anode is a metal selected from the group consisting of lithium (Li), sodium (Na), potassium (K), magnesium (Mg), calcium (Ca), aluminum (Al), germanium (Ge), tin (Sn), silicon (Si), zinc (Zn), nickel (Ni), cobalt (Co), iron (Fe), combinations thereof, and alloys thereof. In some examples, including any of the foregoing, the metal anode is a Li metal anode. In some examples, including any of the foregoing, the metal anode is a Na metal anode. In some examples, including any of the foregoing, the metal anode is a K metal anode. In some examples, including any of the foregoing, the metal anode is a Mg metal anode. In some examples, including any of the foregoing, the metal anode is a Ca metal anode. In some examples, including any of the foregoing, the metal anode is a Al metal anode. In some examples, including any of the foregoing, the metal anode is a Ge metal anode. In some examples, including any of the foregoing, the metal anode is a Sn metal anode. In some examples, including any of the foregoing, the metal anode is a Zn metal anode.

In some examples, the inner container is a pouch containing the metal anode, the cathode, the separator, and the ILE or DES. In some of these examples, the pouch is surrounded by a rigid housing of the outer container. In some other of these examples, the rigid housing is a module or a box. In some of these examples, the rigid housing is selected from a coin cell and can cell. In some examples, the rigid housing is a coin cell. In some examples, the rigid housing is a can cell.

In some examples, including any of the foregoing, the sealable port or outlet for a liquid or gas attached to the inner or outer container includes a FEP tube, a PP tube, a polyethylene tube, a metal tube or a combination thereof. In certain examples, the sealable port for a liquid or gas includes a FEP tube. In certain examples, the sealable port for a liquid or gas includes a PP tube. In certain examples, the sealable port for a liquid or gas includes a polyethylene (PE) tube. In certain examples, the sealable port for a liquid or gas includes a metal tub. In certain examples, the sealable port for a liquid or gas includes a combination of a FEP tube, a PP tube, a polyethylene tube, and a metal tube. In some examples, the sealable port for a liquid or gas includes a metal tube. In some examples, the metal tube is an Al metal tube. In some examples, the sealable port for a liquid or gas includes a FEP tube. In some examples, the sealable port for a liquid or gas includes a PP tube. In some examples, including any of the foregoing, the sealable port for a liquid or gas is about 1-2 mm in diameter.

In some examples, the sealable port for a liquid or gas includes an outer polyethylene tube extending away from the inner container which is connected to a polypropylene tube extending through the inner container. In this example, the polyethylene and polypropylene tubes are bonded or fused together such that the two tubes form a single tube.

In some examples, including any of the foregoing, the sealable port for a liquid or gas includes a FEP tube and the inner container comprises a fluorinated polymer selected from FEP.

### Figures

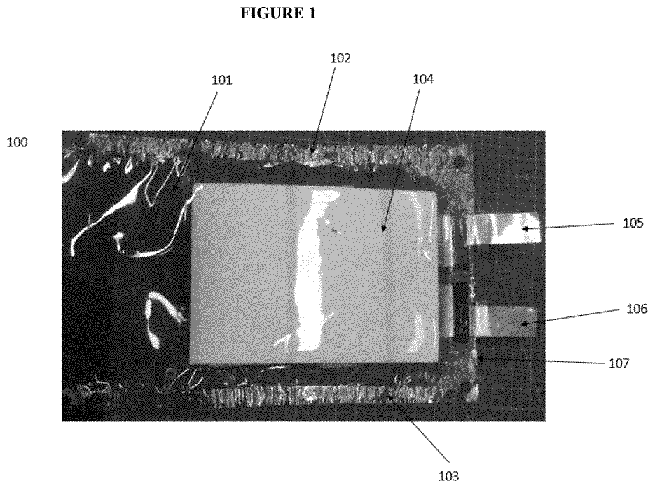

FIG. 1 shows 100: an example set up for the inner container. The inner container comprises one, or multiple, sheets/films/layers of fluorinated polymer. The sheets/films/layers of the fluorinated polymer are heat sealed along edges 102 and 103 to form a unsealed pouch. The battery 104 is placed in the tube. Included in the battery is an aluminum metal anode welded to an Al tab (105) which is used to connect the battery to an external circuit. Included in the battery is a cathode which includes a Ni foil substrate coated with graphite. The cathode is welded to a Ni tab (106) which is used to connect the battery to an external circuit. Included in this battery is a SiO₂ glassy fiber separator (not shown). After placing the battery in the tube, the tube is heat sealed along edge (107) to form a pouch 101. The pouch (101) has the tabs (105) and (106) protruding from the edge (107). Before sealing the side where tabs are, carbon tape is used to seal the contact surface between the inner container (PI/FEP composite or FEP film) and tabs (105) and (106) (Ni and Al).

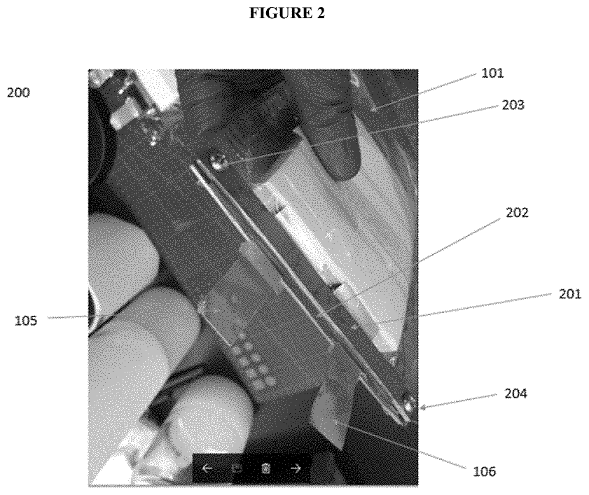

FIG. 2 shows 200: a set up for the inner container and compression apparatus in the battery assembly described herein. In this battery assembly view, the battery (104) is enclosed in an FEP pouch (101). The sealing assembly comprises a top hard plate (201) and a bottom hard plate (202) held together by screws (203) and (204).

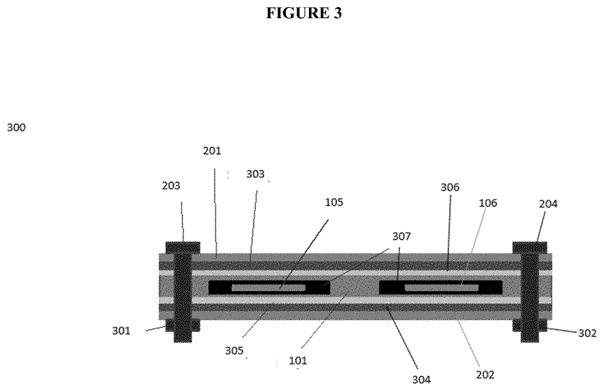

FIG. 3 shows 300: a schematic cross section for the Al-ion battery assembly. The battery core is placed in the inner container (pouch) (101) and the edges are hot-sealed except the bottom, which is used for electrolyte injection. Before sealing the side where current collector tabs (105) and (106) are, carbon tape (307) is used to seal the contact surface between the material of the inner container and the tabs (Ni and Al). The side where the tabs are located is pressed between a top hard plate (201) and a bottom hard plate (202) (e.g., steel hard plates) with a top soft plate (303) and a bottom soft plate (304) (e.g., silicone foam soft plates) as wad. The inner container further comprises a top non-fluorinated polymer layer (306) and a bottom non-fluorinated polymer layer (305) (e.g., polyimide layers). The steel plates are held together by screws (203, 204) and nuts (301, 302). In addition, a Teflon gas valve is installed on the inner container.

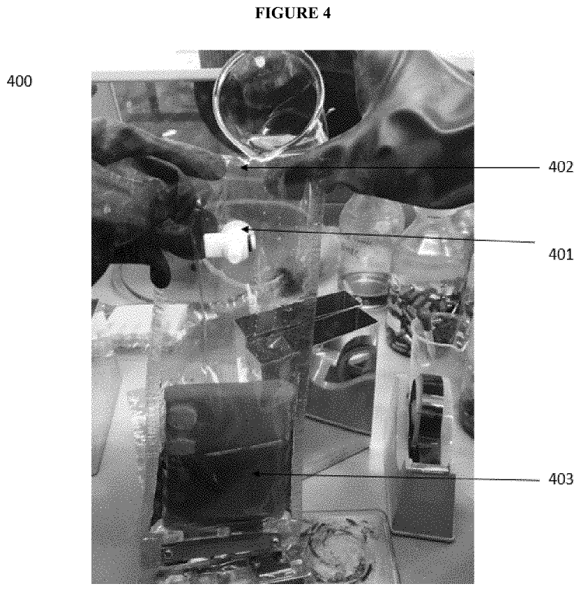

FIG. 4 shows 400: filling of electrolyte in an inner container. A sealable port for a liquid or gas (e.g., Teflon gas valve) (401) is installed in the inner container (e.g., FEP pouch, or FEP pouch further comprising a polyimide layer). The battery pack is transferred into an inert atmosphere for electrolyte injection. The bottom edge (402) which is capable of being unsealed is used for the injection or filling of electrolyte. In some examples, AlCl₃-urea or AlCl₃-amide based ionic liquid or deep eutectic solvent electrolytes may be injected or filled in the pouch. After enough electrolyte is injected or filled, the bottom edge (402) of the pouch is hot-sealed. One pouch or a stack of a plurality of pouches may be placed in an outer container.

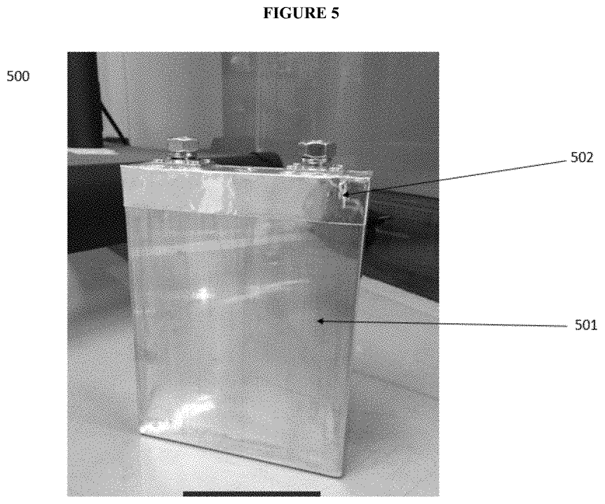

FIG. 5 shows 500: encapsulation in an outer container. The battery pack from FIG. 4 is placed into an aluminum box (501) having a top Al cover (502) in a glovebox in an inert atmosphere. The aluminum box and top Al cover are then sealed by laser beam welding to prevent the stacked battery pouches inside from contacting water or oxygen in the air

In some examples, including any of the foregoing, the cathode in any of the batteries described herein includes carbon selected from natural graphite and synthetic graphite. In some examples, the carbon is natural graphite. In some examples, the carbon is synthetic graphite. Graphite is mined as either vein, flake, or microcrystalline. Herein, graphite can be vein, flake microcrystalline, or a combination thereof. In some examples, the graphite is flake graphite. In some examples, including any of the foregoing, the graphite is natural flake graphite.

In some examples, including any of the foregoing, the graphite is substantially free of defects.

In some examples, including any of the foregoing, the cathode includes pyrolytic graphite.

In some examples, including any of the foregoing, the battery further includes a cathode current collector selected from the group consisting of a glassy carbon, carbon fiber paper, carbon fiber cloth, graphite fiber paper, and graphite fiber cloth. In some of these examples, the battery includes a cathode current collector selected from glassy carbon. In some examples, the battery includes a cathode current collector selected from carbon fiber paper. In some examples, the battery includes a cathode current collector selected from carbon fiber cloth. In some examples, the battery includes a cathode current collector selected from graphite fiber paper. In some examples, the battery includes a cathode current collector selected from graphite fiber cloth. In some of these examples, the carbon fiber paper has a thickness between about 10 μm to 300 μm.

In some examples, including any of the foregoing, the battery further includes a cathode current collector selected from the group consisting of a metal substrate. In some examples, the metal substrate is coated with a protective coating. In some examples, the metal substrate is a mesh or a foil. In certain examples, the substrate is mesh. In certain examples, the substrate is foil. In some examples, the metal is nickel (Ni) or tungsten (W). In certain examples, the metal is Ni. In certain examples, the metal is W. In some examples, the protective coating is selected from a Ni coating, a W coating, a carbon coating, a carbonaceous material, a conducting polymer, and a combination thereof. In certain examples, the protective coating is a Ni coating. In certain examples, the protective coating is a W coating. In certain examples, the protective coating is a carbon coating. In certain examples, the protective coating is a carbonaceous material. In certain examples, the protective coating is a conducting polymer.

In some examples, the metal substrate is a Ni foil, a Ni mesh, a W foil, or a W mesh. In some examples, the metal substrate is a metal foil coated with Ni coating. In some examples, the metal substrate is a metal mesh coated with Ni coating. In some examples, the metal substrate is a metal foil coated with W coating. In some examples, the metal substrate is a metal mesh coated with W coating.

In some examples, including any of the foregoing, the metal substrate is Ni and the protective coating is carbon.

In some examples, including any of the foregoing, the cathode includes natural graphite, synthetic graphite, sulfur, selenium, black phosphorous particles, or combinations thereof. In some examples, including any of the foregoing, the separator includes SiO₂ glass fiber. In some examples, including any of the foregoing, the separator is prepared by a process which includes drying the separator under vacuum at about 200° C.

In some examples, including any of the foregoing, the ILE includes urea. In some examples, including any of the foregoing, the DES includes urea.

In some examples, including any of the foregoing, the DES includes a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof.

In some examples, including any of the foregoing, the ILE includes a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof.

In some examples, including any of the foregoing, the ILE or DES includes a mixture of a metal halide and an organic compound. In some examples, including any of the foregoing, the metal halide is an aluminum halide and the organic compound is as described above and herein.

In some examples, including any of the foregoing, wherein the amount of water or hydrochloric acid in the ionic liquid electrolyte is between 0-1000 ppm. In some examples, including any of the foregoing, the amount of water or hydrochloric acid in the ionic liquid electrolyte is less than 1000 ppm. In some examples, including any of the foregoing, the concentration of corrosion products content in the ionic liquid electrolyte is less than 1000 ppm.

In some examples, including any of the foregoing, the coulombic efficiency does not decay by more than 5 percent over the first 500-10,000 cycles when the battery is cycled under normal operating conditions. In some examples, including any of the foregoing, the specific capacity does not decay by more than 5 percent over the first 500-10,000 cycles when the battery is cycled under normal operating conditions.

In some examples, including any of the foregoing, set forth herein is a battery including: an Al metal anode, Al current collector having an Al tab, a SiO₂ glass fiber separator, a cathode including graphite on Ni foil, and a Ni, W, or C current collector having a Ni, W, or C tab. In some of these examples, at least one current collector is a mesh. In some of these examples, at least one current collector is a foam.

In some of these examples, including any of the foregoing, the battery assembly is flexible and may include one battery in an inner container, or more than one batteries within the inner container.

In some examples, including any of the foregoing, set forth herein is a battery including: a metal anode, a cathode, a separator between the metal anode and the cathode, an ionic liquid electrolyte (ILE) or deep eutectic solvent electrolyte (DES) including a metal halide salt and an organic compound in direct contact with the metal anode, the cathode, and the separator, a chemically compatible enclosure forming an inner container and in direct contact with the ILE or DES and encapsulating the metal anode, the cathode, the separator, and the ILE or DES, and a sealable port or outlet for a liquid or gas extending through, and sealed to, the chemically compatible enclosure (inner container), and an outer container, wherein, a negative pressure is maintained across the wall of the inner container (e.g., by maintaining a reduced pressure (vacuum) in the area between the inner and outer containers).

In some examples, including any of the foregoing, the inner container's pouch is a prismatic pouch.

### Electrolytes

In some examples, set forth herein is an ionic liquid electrolyte (ILE) or deep eutectic solvent (DES) including a mixture of a metal halide and an organic compound, wherein water content of the electrolyte is less than 1000 ppm. As used herein, ILE refers to ionic electrolytes which include ionically bonded chemical species. As used herein, DES refers to ionic electrolytes which include ionically bonded chemical species as well as non-ionically bonded chemical species, e.g., species which are bonded through hydrogen-bonds. In some examples, hydrogen bonding in a given DES can dominate (i.e., be stronger) ionic bonding.

In some examples, including any of the foregoing, the ILE or DES includes a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof. In certain examples, the ILE or DES includes alkylimidazolium aluminates. In certain examples, the ILE or DES includes alkylpyridinium aluminates. In certain examples, the ILE or DES includes alkylfluoropyrazolium aluminates. In certain examples, the ILE or DES includes alkyltriazolium aluminates. In certain examples, the ILE or DES includes aralkylammonium aluminates. In certain examples, the ILE or DES includes alkylalkoxyammonium aluminates. In certain examples, the ILE or DES includes aralkylphosphonium aluminates. In certain examples, the ILE or DES includes aralkylsulfonium aluminates. In certain examples, the ILE or DES includes alkylguanidinium aluminates.

In some examples, including any of the foregoing, the ILE or DES includes urea.

In some examples, including any of the foregoing, the metal halide is an aluminum halide.

In some examples, including any of the foregoing, the aluminum halide is AlCl₃.

In some examples, including any of the foregoing, the aluminum halide is AlCl₃, and the organic compound includes: (a) cations selected from the group consisting of N-(n-butyl) pyridinium, benzyltrimethylammonium, 1,2-dimethyl-3-propylimidazolium, trihexyltetradecylphosphonium, and 1-butyl-1-methyl-pyrrolidinium, and (b) anions selected from the group consisting of tetrafluoroborate, tri-fluoromethanesulfonate, and bis(trifluoromethanesulfonyl)imide.

In some examples, including any of the foregoing, the aluminum halide is AlCl₃, and the organic compound is selected from 4-propylpyridine, acetamide, N-methylacetamide, N,N-dimethylacetamide, trimethylphenylammonium chloride, 1-ethyl-3-methylimidazolium bis(trifluoromethylsulfonyl)imide and 1-ethyl-3-methylimidazolium chloride.

In some examples, including any of the foregoing, the aluminum halide is AlCl₃, and the organic compound is 1-ethyl-3-methylimidazolium chloride.

In some examples, including any of the foregoing, the ILE includes an aluminum halide cation that is datively bonded to the organic compound.

In some examples, including any of the foregoing, the aluminum halide is AlCl₃, and the organic compound is an amide. In some of these examples, the amide is selected from urea, methylurea, ethylurea, and combinations thereof. In certain examples, the amide is urea. In certain examples, the amide is methylurea. In certain examples, the amide is ethylurea.

In some examples, including any of the foregoing, the metal halide is AlCl₃; and the organic compound is selected from 1-ethyl-3-methyl imidazolium chloride, 1-ethyl-3-methlimidazolium bis(trifluoromethylsulfonyl)imide, urea, methylurea, ethylurea, mixtures thereof, and combinations thereof.

In some examples, including any of the foregoing, the ILE includes AlCl₃ and 1-ethyl-3-methyl imidazolium chloride, the mole ratio of AlCl₃: 1-ethyl-3-methyl imidazolium chloride is from 1.1 to 1.7. In some examples the mole ratio is 1.1. In some examples the mole ratio is 1.2. In some examples the mole ratio is 1.3. In some examples the mole ratio is 1.4. In some examples the mole ratio is 1.5. In some examples the mole ratio is 1.6. In some examples the mole ratio is 1.7.

In some examples, including any of the foregoing, the ILE includes a mixture of 1.1 to 1.7 moles AlCl₃, 1.0 mole 1-ethyl-3-methyl imidazolium chloride and 0.1 to 0.5 mole 1-ethyl-3-methylimidazolium bis(trifluoromethylsulfonyl)imide. In some examples, the mixture includes 1.1, 1.2, 1.3, 1.4, 1.5, 1.6, or 1.7 moles AlCl₃. In some examples, the mixture includes 0.1, 0.2, 0.3, 0.4, or 0.5 moles 1-ethyl-3-methylimidazolium bis(trifluoromethylsulfonyl)imide. In some examples, the mixture includes 0.1, 0.2, 0.3, 0.4, or 0.5 moles 1-ethyl-3-methylimidazolium tetrafluoroborate. In some examples, the mixture includes 0.1, 0.2, 0.3, 0.4, or 0.5 moles 1-ethyl-3-methylimidazolium hexafluorophosphate,

In some examples, including any of the foregoing, the ILE includes AlCl₃ and urea. In some examples, including any of the foregoing, the ILE includes AlCl₃ and methylurea.

In some examples, including any of the foregoing, the mole ratio of AlCl₃ to ILA′ in the ILE is between 1.1 to 1.7.

In some examples, including any of the foregoing, the mole ratio of AlCl₃ to ILA″ is between 1.1 to 1.7.

In some examples, including any of the foregoing, the ILE is ILA′ and the mole ratio of AlCl₃:urea about 1.1 to about 1.7.

In some examples, including any of the foregoing, the ILE is ILA′ and the mole ratio of AlCl₃:methylurea is about 1.1 to about 1.7.

In some examples, including any of the foregoing, the ILE is ILA′ and the mole ratio of AlCl₃:ethylurea is about 1.1 to about 1.7.

In some examples, including any of the foregoing, the amount of water or hydrochloric acid in the ionic liquid electrolyte is between 0-1000 ppm. In some examples, including any of the foregoing, the amount of water or hydrochloric acid in the ionic liquid electrolyte is less than 1000 ppm. In some examples, including any of the foregoing, the concentration of corrosion products content in the ionic liquid electrolyte is less than 1000 ppm.

Examples of ionic liquids include aluminates, such as ones including, or formed from, a mixture of an aluminum halide and an organic compound. To reduce the water content in the ionic liquid, the organic compound can be subjected to heating and drying under reduced pressure, such as heating in vacuum (e.g., about 10⁻² Torr, about 10⁻³ Torr, or less, and about 70° C.-110° C.) to remove water prior to mixing with an aluminum halide slowly under stirring with cooling to maintain a temperature near room temperature. For example, a suitable ionic liquid can include, or can be formed from, a mixture of an aluminum halide (e.g., AlCl₃) and urea; other aliphatic amides including from 1 to 10, 2 to 10, 1 to 5, or 2 to 5 carbon atoms per molecule, such as acetamide, as well as cyclic (e.g., aromatic, carbocyclic, or heterocyclic) amides, as well as combinations of two or more different amides are contemplated. In some examples, a suitable ionic liquid can include, or can be formed from, a mixture of an aluminum halide (e.g., AlCl₃) and 4-propylpyridine; other pyridines, as well as other N-heterocyclic compounds (including EMIC or EMI) with 4 to 15, 5 to 15, 4 to 10, or 5 to 10 carbon atoms per molecule, as well as combinations of two or more different N-heterocyclic compounds are contemplated. In some examples, a suitable ionic liquid for high temperature operations can include, or can be formed from, a mixture of an aluminum halide and trimethylphenylammonium chloride; other cyclic (e.g., aromatic, carbocyclic, or heterocyclic) compounds including a cyclic moiety substituted with at least one amine or ammonium group, as well as aliphatic and cyclic amines or ammoniums, as well as combinations of two or more different amines or ammoniums are contemplated. In some examples, a suitable organic compounds include N-(n-butyl) pyridinium chloride, benzyltrimethylammonium chloride, 1,2-dimethyl-3-propylimidazolium, trihexyltetradecylphosphonium chloride, and 1-butyl-1-methyl-pyrrolidinium cations with anions such as tetrafluoroborate, tri-fluoromethanesulfonate and bis(trifluoromethanesulfonyl) imide.

In some embodiments, the aluminum halide is AlCl₃, and the organic compound incudes cations selected from N-(n-butyl) pyridinium, benzyltrimethylammonium, 1,2-dimethyl-3-propylimidazolium, trihexyltetradecylphosphonium, and 1-butyl-1-methyl-pyrrolidinium, and anions selected from tetrafluoroborate, tri-fluoromethanesulfonate, and bis(trifluoromethanesulfonyl)imide.

In some embodiments, the aluminum halide is AlCl₃, and the organic compound is selected from 4-propylpyridine, acetamide, trimethylphenylammonium chloride, and 1-ethyl-3-methylimidazolium chloride.

In some embodiments, the ILE or DES does not wet the chemically compatible enclosure (e.g. the fluorinated polymer) or the inner container.

### Protective Covers

In some examples, set forth herein is a protective cover or outer container for a metal anode battery, the metal anode battery including: a metal anode, a cathode, a separator, and an ionic liquid electrolyte (ILE); and the protective cover including a fluorinated polymer seal which encapsulates the metal anode, the cathode, the separator, and the ionic liquid electrolyte, and a sealable port for a liquid or gas, wherein the port is transverse to the fluorinated polymer seal.

In some examples, the outer container is comprises a sealable port of outlet for liquid or gas.

### Processes for Making a Rechargeable Battery

PCT International Application PCT/US2018/026968 filed on Apr. 10, 2018, titled “BATTERY WITH LONG CYCLE LIFE” describes methods of making certain batteries, which disclosure is incorporated herein by reference.

In another aspect, provided herein is a process for assembling a battery, the process comprising:
placing a battery cell and an electrolyte into an inner container;
vacuum sealing the inner container after the battery cell and the electrolyte are placed into the inner container to form a sealed inner container;
placing a second battery cell and a second electrolyte into a second inner container;
vacuum sealing the opening after the second battery cell and the second electrolyte are placed into the second inner container to form a second sealed inner container;
placing the sealed inner container and sealed second inner container inside an outer container;
sealing the outer container; and
creating a vacuum or inert environment in the outer container while the inner container is encased inside the outer container, the vacuum, when present, forming a pressure gradient between a region outside of the inner container and a region inside of the inner container.

In one instance the outer container maintains a vacuum and allows for a negative gradient across the wall of the inner container. In another example, the outer container was filled with an inert gas but maintains a reduce pressure to allow for a negative pressure gradient across the wall of the inner container.

In one instance the placing a battery cell and an electrolyte into an inner container is carried out through an opening in the inner container. In one instance the placing a second battery cell and an electrolyte into an inner container is carried out through an opening in the inner container.

Also provided herein is a process for assembling a battery, the process comprising:
placing a battery cell and an electrolyte into an inner container;
vacuum sealing the inner container after the battery cell and the electrolyte are placed into the inner container to form a sealed inner container;
after sealing of the opening, cycling the battery cell;
optionally after or while cycling the battery, removing the gas from within the inner container;
cutting and shortening the inner container to form a cut and shortened inner container;
vacuum sealing the cut and shortened inner container;
placing the sealed inner container inside an outer container;
sealing the outer container; and
creating a vacuum or inert environment in the outer container while the inner container is encased inside the outer container, the vacuum, when present, forming a pressure gradient between a region outside of the inner container and a region inside of the inner container.

In one instance the placing a battery cell and an electrolyte into an inner container is carried out through an opening in the inner container.

In one instance, the process comprises partially sealing the outer container; creating a vacuum or inert environment in the outer container while the inner container is encased inside the outer container, the vacuum, when present, forming a pressure gradient between a region outside of the inner container and a region inside of the inner container; and fully sealing the outer container.

In one instance, provided herein is a process for assembling a battery, the process comprising:
placing a battery cell and an electrolyte into an inner container;
vacuum sealing the inner container after the battery cell and the electrolyte are placed into the inner container to form a sealed inner container;
after sealing of the opening, cycling the battery cell;
optionally after or while cycling the battery, removing the gas from within the inner container;
cutting and shortening the inner container to form a cut and shortened inner container;
vacuum sealing the cut and shortened inner container;
placing the sealed inner container inside an outer container;
creating a vacuum or inert environment in the outer container while the inner container is encased inside the outer container, the vacuum, when present, forming a pressure gradient between a region outside of the inner container and a region inside of the inner container; and
sealing the outer container.

Further provided is a process for assembling a battery, the process comprising:
placing a battery cell and an electrolyte through an opening of and into an inner container;
vacuum sealing the opening after the battery cell and the electrolyte are placed into the inner container;
after sealing of the opening, cycling the battery;
optionally after or while cycling the battery, removing the gas from within the inner container;
placing the sealed inner container inside an outer container;
sealing the outer container; and
creating a vacuum or inert environment in the outer container while the inner container is encased inside the outer container, the vacuum, when present, forming a pressure gradient between a region outside of the inner container and a region inside of the inner container.

In one instance the placing a battery cell and an electrolyte into an inner container is carried out through an opening in the inner container.

In some examples of the battery assembly processes described above, the processes comprise injecting the electrolyte into the inner container. In some instances the electrolyte is poured into the inner container.

In some examples of the battery assembly processes described above, the inner container comprises a sealable port for liquids or gases. In some examples, the inner container comprises a seal at the outlet, wherein the seal is configured to allow removal of gas from within the inner container.

In some examples of the battery assembly processes described above, the outer container comprises a sealable port for liquids or gases. In some embodiments, the outer container comprises a seal at the outlet, wherein the seal is configured to allow removal of gas from within the outer container.

In some examples, set forth herein is a process for conditioning a battery, the process comprising:
providing a battery assembly described above; and
removing a gas from a region within the battery assembly by forming a vacuum, the region disposed between the inner container and the outer container, and the vacuum forming a negative pressure gradient across a wall of the inner container.

In one instance, the process for conditioning a battery further comprises cycling at least one battery cell in the battery assembly. Advantageously, removing a gas from the region disposed between the inner container and the outer container creates vacuum, i.e., a negative pressure gradient across a wall of the inner container. This negative pressure gradient continues to draw contaminants in the electrolyte, or which are produced in the electrolyte when the battery is cycled, across the inner container and into the region disposed between the inner container and the outer container. This improves the life of the battery by removing contaminants that would otherwise degrade the performance of the battery cell.

In one instance, in the process for conditioning a battery, before removing the gas, the battery cell has a first charge/discharge capacity, and after removing the gas, the battery cell has a second charge/discharge capacity that is greater than the first charge/discharge capacity. In some of such instances, before removing the gas, the battery cell has a first cycle life, and after removing the gas, the battery cell has a second cycle life that is greater than the first cycle life.

In an embodiment, when batteries or battery assemblies such as those described herein are cycled and subjected to vacuum-pumping, the liquids and gases that are vacuum-pumped out of the battery are vacuum-pumped through the sealable port for a liquid or gas which is sealed to the inner container. In a different embodiment, when batteries or battery assemblies such as those described herein are cycled and subjected to vacuum-pumping, the liquids and gases are vacuum-pumped out of the space between the inner container and the outer container. In a further embodiment, when batteries or battery assemblies such as those described herein are cycled and subjected to vacuum-pumping, removal of liquids and gases out of the space between the inner container and the outer container creates a negative pressure gradient across the wall of the inner container which facilitates removal of gases/liquids from the battery pouches.

Incorporated by reference are the processes for making a rechargeable batteries and the components thereof set forth in US 2015-0249261; WO 2015/131132; Lin, M-C, et al., Nature, 2015, p. 1- doi:1038/nature143040; and Angell, et al., PNAS, Early Edition, 2016, p. 1-6, doi:10.1073/pnas.1619795114.

Set forth herein are processes for manufacturing a metal-ion battery including providing an metal anode; providing a cathode; and providing an ionic liquid electrolyte, wherein providing the ionic liquid electrolyte includes: combining an aluminum halide and an organic compound to form an ionic liquid. In some examples, prior to the combining step, the ionic liquid is subjected to vacuum-pumping for about 0.2 hours (h) to about 24 h to remove residual water, hydrochloric acid or organic impurities. In some examples, the vacuum is about 0.1 Torr or less. In some examples, the processes include subjecting the organic compound to heating in vacuum to about 70° C.-110° C. to remove water prior to mixing with the aluminum halide slowly under stirring with cooling to maintain a temperature of about room temperature. In some examples, the processes include providing a separator selected from a porous membrane, such as a glass fiber membrane, a regenerated cellulose membrane, a polyester membrane or a polyethersulfone membrane, or other hydrophobic membrane, such as polyethylene membrane, wherein the porous membrane is optionally further coated with a hydrophilic polymer such as polyacrylic acid and polyvinyl alcohol, and cross-linked by heating.

In some implementations, a reduced content of residual water, HCl and organic impurities can be attained by subjecting the electrolyte, once formed, to a purification procedure. For example, set forth herein, in some examples, are processes for removing HCl in the electrolyte formed by residual water or HCl gas resulting from the residual water by subjecting the electrolyte to reduced pressures, such as under vacuum (e.g., about 0.1 Torr, about 10⁻² Torr, about 10⁻³ Torr, or less) for about 0.2 h to about 24 h or for about 0.5 h to about 24 h, until noticeable bubbling ceases. In some other examples, set forth herein are processes for removing HCl and organic impurities, by adding one or more metal pieces of aluminum foil to the electrolyte, and, after agitation for a period of time, subjecting the electrolyte to reduced pressures, such as under vacuum (e.g., about 0.1 Torr, about 10−2 Torr, about 10−3 Torr, or less) for about 0.2 h to about 24 h at 25-90° C. or for about 0.5 h to about 24 h at 25-90° C. Assembled batteries in some examples are also subjected to vacuum again to remove any residual water and/or acids prior to sealing the battery.

In some examples, set forth herein is a process for making a battery, including the following steps providing a battery set forth herein, and reducing the pressure inside the battery by drawing a vacuum while cycling the battery at least two or more times. The process of reducing the pressure in or around the sealed electrochemical cell removes volatile components by way of vacuum-pumping. In some examples, these volatile components are generated as a consequence of the charge-discharge cycling of the battery.

In some examples, herein, the vacuum-pumping of the electrochemical cell does not just cause water to be removed. By cycling the electrochemical cell while vacuum-pumping, the processes herein remove volatile species which are formed in the electrochemical cell as a side reaction of the cycling process. For example, by cycling the electrochemical cell while vacuum-pumping, the processes herein remove species, such as not limited to, HCl and any proton containing hydrocarbon. In some examples, at least two cycles while vacuum-pumping is used in the processes herein. In some examples, at least ten cycles while vacuum-pumping is used in the processes herein.

In some of these examples, the process removes residual water, hydrochloric acid, organic impurities, or combinations thereof from the electrolyte. In some examples, the process removes side reaction products such as hydrogen at the battery cathode and anode during battery cycling.

In some examples, including any of the foregoing, providing a battery includes forming at least one or more electrochemical cells, each including a metal anode, a cathode, a separator, and an ionic liquid electrolyte (ILE) deep eutectic solvent (DES). In this example, the ILE or DES includes a mixture of a metal halide salt and an organic compound. In some examples, the processes include forming two or more electrochemical cells which are stacked in parallel. In some examples, the processes include forming two or more electrochemical cells which are stacked in series.

In some examples, including any of the foregoing, the processes further include sealing a fluorinated polymer enclosure to encapsulate the at least one or more electrochemical cells. The sealing can be accomplished with an impulse sealer or similar instrument.

In some examples, including any of the foregoing, the processes include reducing the pressure in the battery by drawing a vacuum while cycling the battery at least 30 charge-discharge cycles.

In some examples, including any of the foregoing, the processes include at least 60 or more times.

In some examples, including any of the foregoing, the processes include reducing the pressure to greater than, or equal to, 5 Pascal (Pa) and less than 101,325 Pa. In some examples, the processes include reducing the pressure to at least 5 Pascal (Pa). In some examples, the processes include reducing the pressure to at least 0.1 Torr (13.33 Pa) or less.

In some examples, including any of the foregoing, the processes include cycling at 100 mA/g.

In some examples, including any of the foregoing, the processes include cycling the battery at room temperature between 1 V to 2.4 V.

In some examples, including any of the foregoing, the processes include cycling the battery at room temperature between 2.1 to 2.4 V.

In some examples, including any of the foregoing, the processes include cycling the battery at −20° C. from between 1 to 2.7 V.

In some examples, including any of the foregoing, the processes include cycling the battery at −20° C. from between 2.1 to 2.7 V.

In some examples, including any of the foregoing, the processes include cycling the battery at room temperature and a cut-off voltage between the cathode and anode of 2.4V.

In some examples, including any of the foregoing, the processes include cycling the battery at room temperature and a cut-off voltage between the cathode and anode of 2.7 V.

In some examples, including any of the foregoing, the processes include cycling the battery at temperatures lower than −20° C. and a cut-off voltage between the cathode and anode of 2.7 V.

In some examples, including any of the foregoing, the processes include the cycling the battery at −20° C. and a cut-off voltage up to 2.7V.

In some examples, including any of the foregoing, the metal anode is an Al metal anode and the processes further include polishing the Al metal anode in an inert gas environment prior to the step of providing a battery. This polishing removes any native oxide or surface oxide present on the Al metal anode and thereby improves its electrical contact to that which it is laminated or bonded to.

In some examples, including any of the foregoing, the providing a battery includes first degassing the ionic liquid electrolyte in the battery which is later injected into the battery. In some of these examples, the degassing includes subjecting the organic compound to heating in vacuum to about 60° C. to remove water prior to mixing the organic compound with an aluminum halide slowly under stirring with cooling to maintain a temperature of about room temperature.

In some of these examples, the organic compound is selected from 1-ethyl-3-methylimidazolium chloride, urea, methylurea, and ethylurea. In certain examples, the organic compound is 1-ethyl-3-methylimidazolium chloride, In certain examples, the organic compound is urea. In certain examples, the organic compound is methylurea. In certain examples, the organic compound is ethylurea.

In some examples, including any of the foregoing, the providing a battery includes injecting the ionic liquid electrolyte through a sealable port for a liquid or a gas in a chemically compatible enclosure surrounding the battery or the at one or more electrochemical cells.

In some examples, including any of the foregoing, the processes include monitoring at least one metric selected from current density, voltage, impedance, pressure, temperature and capacity while reducing the pressure in or around the battery by drawing a vacuum while cycling the battery.

In some examples, including any of the foregoing, the processes include sealing the port for a liquid or gas after reducing the pressure in or around the battery by drawing a vacuum while cycling the battery.

In some examples, including any of the foregoing, the processes include placing an outer container around the battery stack and reducing the pressure in or around the battery by drawing a vacuum while cycling the battery after the battery has been cycled without reducing the pressure in or around the battery. In some instances, the processes include maintain a negative pressure across the wall of the inner container in the battery assembly.

In some examples, including any of the foregoing, the processes include reducing the pressure in or around the battery by drawing a vacuum while cycling the battery after the battery has been cycled without reducing the pressure in or around the battery occurs subsequent to measuring a capacity or coulombic efficiency decay during the cycling.

In some examples, also set forth herein is a battery made by a process set forth herein.

In some other examples, set forth herein is a process of making an ionic liquid electrolyte (ILE) or deep eutectic solvent (DES), including the following steps: providing an ILE or DES in a sealed electrochemical cell, wherein the ILE includes a mixture of a metal halide and an organic compound; and reducing the pressure in or around the sealed electrochemical cell by drawing a vacuum while cycling the electrochemical cell at least two or more times. The process of reducing the pressure in or around the sealed electrochemical cell removes volatile components by way of vacuum-pumping. In some examples, these volatile components are generated during the charge-discharge cycling of the battery.

In some of these examples, the process removes residual water, hydrochloric acid, organic impurities, or combinations thereof from the electrolyte. In some examples, the process removes side reaction products such as hydrogen at the battery cathode and anode during battery cycling.

In some examples, including any of the foregoing, the metal anode is an Al metal anode and the processes further include polishing the Al metal anode in an inert gas environment prior to the step of providing a battery. This polishing removes any native oxide or surface oxide present on the Al metal anode and thereby improves its electrical contact to that which it is laminated or bonded to.

In some examples, including any of the foregoing, the providing a battery includes first degassing the ionic liquid electrolyte in a sealed electrochemical cell which is later injected into the battery. In some of these examples, the degassing includes subjecting the organic compound to heating in vacuum to about 60° C. to remove water prior to mixing the organic compound with an aluminum halide slowly under stirring with cooling to maintain a temperature of about room temperature.

In some of these examples, the organic compound is selected from 1-ethyl-3-methylimidazolium chloride, urea, methylurea, and ethylurea. In certain examples, the organic compound is 1-ethyl-3-methylimidazolium chloride. In certain examples, the organic compound is urea. In certain examples, the organic compound is methylurea. In certain examples, the organic compound is ethylurea.

In some examples, set forth herein is a process of making an ionic liquid or deep eutectic solvent electrolyte for rechargeable metal ion battery, the process including providing an ionic liquid electrolyte in an electrochemical cell that is sealed under vacuum; and reducing the pressure in or around the electrochemical cell by drawing a vacuum on or around the ionic liquid electrolyte while cycling the electrochemical cell at least two or more times.

### Processes for Making an Electrolyte to Use in a Rechargeable Battery

In some examples, an electrolyte is made by first mixing a strong Lewis acid metal halide and Lewis base ligand. For example, the following electrolytes can be made. Generally, the strong Lewis acid metal halide is contacted with a dried Lewis Base ligand. The mixture is heated. Then the mixture is cooled.

For example, set forth herein in certain embodiments is an AlCl₃:Urea electrolyte. In this electrolyte, in some examples, the urea is dried at about 60-80° C. under vacuum for about 24 hours. In some examples, the urea is then transported to the glovebox in a vacuum sealed container. In some examples, if the urea is heated past its melting point, the resulting electrolyte (after mixing with AlCl₃) is viscous, sometimes forming a solid. In some examples, set forth herein is a step wherein AlCl₃ is slowly added to the urea in a glass vial in a mole ratio of about 1.3:1, about 1.5:1, about 1.7:1, or about 2:1 AlCl₃:urea. In some examples, the mixtures are then heated at 60-80° C. to form a liquid product and the cooled to room temperature. In some examples, the AlCl₃:urea mixtures are heated at lower temperatures (e.g., below about 80° C. or between about 30-40° C.).

For example, set forth herein in certain embodiments is an AlCl₃:Acetamide electrolyte. In some examples, the acetamide is dried by heating it to about 100-120° C. while bubbling nitrogen through it. In some examples, the acetamide is then immediately moved to the glovebox. In some examples, set forth herein is a step wherein AlCl₃ is slowly added to the acetamide under constant magnetic stirring in a mole ratio of about 1.5:1 AlCl₃:acetamide. In some examples, the mixture is then heated at 60-80° C. to form a liquid product and the cooled to room temperature. In some examples, the AlCl₃:urea mixtures are heated at lower temperatures (e.g., below about 80° C. or between about 30-40° C.).

Also set forth herein in certain embodiments is an AlCl₃:4-Propylpyridine electrolyte. In some examples, the 4-propylpyridine (TCI, >97%) is dried over molecular sieves for multiple days. In some examples, set forth herein is an additional step wherein AlCl₃ is added slowly under constant magnetic stirring. In certain examples, at about the 1:1 equivalence point, a white solid forms. In some further examples, once a homogenous liquid reaction product has formed and ample time for the 4-propylpyridine to completely react passes (about 24 hours), set forth herein is a step wherein the sampled is dried at about 60-80° C. under vacuum for about 24 hours and transported to the glovebox in a vacuum sealed container. In some examples, set forth herein is a step wherein aluminum foil is added to this electrolyte. In some of these examples, the addition of Al induces a slight color change, which varies depending on the source of aluminum chloride used.

Also set forth herein in certain embodiments is an AlCl₃:Trimethylphenylammonium chloride electrolyte.

In some examples, trimethylphenylammonium chloride (TMPAC) (Sigma Aldrich) is used. In some examples, set forth herein are mixtures with mole ratios of AlCl₃:TMPAC of about 1.7:1 and about 1.3:1 which are made at room temperature by adding TMPAC directly to AlCl₃ under constant magnetic stirring. In some examples, HCl is removed by drying at about 60-80° C. under vacuum for about 24 hours and adding aluminum foil.

In some examples, set forth herein are processes for preparing and purifying an electrolyte such as but not limited to AlCl₃/EMIC, which has a mole ratio of AlCl₃/EMIC of about 1.3:1.

In certain examples, EMIC is pre-heated at about 70° C. under vacuum in an oven for about 1 day to remove residual water and then immediately moved into a glovebox. In some of these examples, about 1.78 g EMIC is added into an about 20 mL vial at room temperature, followed by slow addition of about 2.08 g AlCl₃ in 4-5 portions, mixing for about 5-10 min during each portion. In certain examples, vigorous stirring is maintained throughout the mixing process. Once all AlCl₃ was dissolved, in some examples, set forth herein is a step in which small Al pieces are added to the electrolyte and stirred overnight at room temperature. Subsequently, the electrolyte is held under vacuum for about 20 min in the anti-chamber of the glovebox. In some examples, the treated electrolyte is then stored in the glovebox for further use.

In some examples, HCl gas resulting from residual water is removed using vacuum (about 10⁻³ Torr) pumping until noticeable bubbling ceases.

In some examples, to remove organic impurities, metallic impurities, aluminum foil (Alfa Aesar, 99%) is added to an electrolyte after removal of the surface oxide layer using sand paper. After stirring overnight at 25-90° C., in some examples, the electrolyte is placed under vacuum once more before addition to the battery, at which point it was a clear liquid.

### Processes for Making a Cathode to Use in a Rechargeable Battery

In some examples, set forth herein are processes of making a cathode suitable for use in a rechargeable battery.

In some embodiments, the cathode includes a metal substrate. In some examples, the metal substrate is a nickel substrate and it includes a protective coating of a carbonaceous material derived from pyrolysis of organic compounds deposited on the metal substrate from solution or gas phase, or a conducting polymer deposited on the metal substrate.

Bare Ni foil or Ni foam can be used as current collectors or the aforementioned substrate. Natural graphite particles can be loaded onto such a Ni-based substrate with a binder. Ni and W are found to be more resistive to corrosion in Al-ion battery than most other metals on the cathode side.

Ni foil or Ni foam can be coated with a carbon or graphite layer by various processes to impart enhanced corrosion resistance. One such method is to grow a carbon or graphitic layer on Ni by coating Ni with a carbon-rich material, such as pitch dissolved in a solvent, and then heating at about 400-800° C. Another protective coating is a conducting polymer layer such as poly(3,4-ethylenedioxythiophene) polystyrene sulfonate (PEDOT:PSS). A graphite/polymer binder can also coat Ni densely and act as a protection layer as well as an active cathode layer.

In some examples, set forth herein are cathodes having polymer binders with graphite particles. For example, a polyacrylic acid (PAA)/polyvinyl alcohol (PVA)-based polymer binder for graphite particles can be used.

In some examples, natural graphite particles are dispersed in water containing about 10 wt % PAA and about 3 wt % PVA and stirred to make a slurry. The slurry is applied to a current collector as described above, at a loading of about 2-20 mg/cm², followed by drying at about 70-150° C. in vacuum for about 3 hours or longer to thoroughly remove water, leaving graphite particles packed on the current collector to form a cathode for an Al battery. Further, several weight percent of graphite fibers can be added to the slurry to improve electrical conductivity of the cathode.

In some examples, a carboxymethyl cellulose (CMC)/styrene-butadiene rubber (SBR)/graphite fiber-based polymer binder is used with graphite particles.

In some examples, set forth herein are processes which include using natural graphite particles dispersed in a water slurry containing about 10 wt % CMC and about 1 wt % SBR. In some examples, the slurry is applied to a current collector as described above, at a loading of about 2-20 mg/cm², followed by drying at about 70-200° C. in vacuum for about 3 hours or longer to thoroughly remove water, leaving graphite particles packed on the current collector to form a cathode for an Al battery. In some examples, graphite fibers can be added to the slurry to improve electrical conductivity of the cathode.

In some examples, a PEDOT/PSS/graphite fiber-based polymer binder for graphite particles is used.

In some examples, set forth herein are processes which include using natural graphite particles dispersed in water slurry containing about 10 wt % PEDOT and about 1 wt % PSS conducting polymer. In some examples, the slurry is applied to a current collector as described above, at a loading of about 2-20 mg/cm², followed by drying at about 70-200° C. in vacuum for about 3 hours or longer to thoroughly remove water, leaving graphite particles packed on the current collector to form a cathode for an Al battery. In some examples, graphite fibers can be added to the slurry to improve electrical conductivity of the cathode.

In some examples, an ionic liquid polymer binder for graphite particles is used.

In some examples, set forth herein are processes which include using natural graphite particles are dispersed in a water slurry containing ionic liquid polymer or oligomer. In some examples, the slurry is applied to a current collector as described above, at a loading of about 2-20 mg/cm², followed by drying at about 70-200° C. in vacuum for about 3 hours or longer to thoroughly remove water, leaving graphite particles packed on the current collector to form a cathode for Al battery.

In some examples, slurries useful with the compositions and processes described herein include the following.

In some examples, a slurry includes about 89 wt % graphite particles (grade 3061)/about 4 wt % CMC/about 2 wt % SBR/about 5 wt % graphite fibers, on ELAT® carbon fiber cloth, 70° C. annealed for about 2 h). In some examples, also included is about 802 mg of 3 wt % Na-CMC gel in de-ionized (DI)water, about 241 mg of 5 wt % SBR dispersed in DI water, about 30 mg of chopped graphite fiber, about 534 mg of graphite (grade 3061), and about 1.2 mL of DI water.

In some examples, a slurry includes about 87 wt % graphite particles/about 10 wt % PAA/about 3 wt % PVA, on M30 carbon fiber paper, 130° C. annealed for about 2 h). In some examples, also included is about 225 mg of 25 wt % PAA aqueous solution, about 169 mg of 10 wt % PVA aqueous solution, about 489 mg of graphite particles, and about 0.4 mL of DI water.

### Processes for Making an Electrode and Pouch Cell

In some examples, set forth herein are processes for fabricating an electrode and pouch cell:

An electrode is made, in some examples, by using a small spatula to uniformly coat a slurry onto a substrate (ELAT or M30, about 2 cm²). The electrode is dried on a hot plate at about 100° C. for about 5 min and weighed to evaluate the loading. Afterwards, the electrode is vacuum-annealed for about 2 h at about 70° C. or about 130° C. The heated electrode is immediately weighed to calculate the exact loading and then used to fabricate a pouch cell (electrolyte not yet present). The fabricated pouch was heated at about 70° C. overnight under vacuum and then immediately moved into the glovebox. Finally the pouch was filled by the purified 1.3 ratio electrolyte, held under vacuum for about 2 min in the ante-chamber, and sealed.

In some examples, during manufacturing, graphite particles (or other cathode active material) can be mixed or otherwise combined with a hydrophilic polymer binder along with a suitable solvent (e.g., water) to form a slurry, and the slurry can be coated or otherwise applied to form a cathode material on a current collector. For example, the cathode can be formed by making a slurry of a cathode active material, such as natural graphite particles, dispersed in a hydrophilic polymer binder solution in water, applying the slurry on the current collector, and annealing to a temperature between about 70° C. to about 250° C. in vacuum. In the case of a mixed polymer binder containing PAA and PVA, annealing crosslinks the two polymers to form an extended polymer binder network with high hydrophilicity and binding ability for active cathode materials.

To afford resistance against corrosion when used in the current collector, a metal substrate (e.g., Ni foil or Ni foam) can be applied with a protective coating, such as including a carbon-containing (or carbonaceous) material derived from pyrolysis of organic compounds deposited on the metal substrate. For example, a carbon or graphitic layer can be formed on Ni by coating Ni with a carbonaceous material, such as pitch dissolved in a solvent, and then heating at about 400° C. to about 800° C. Another example of a protective coating is a coating of a conducting polymer deposited on the metal substrate, such as PEDOT:PSS. In place of a metal substrate, a carbonaceous or carbon-based substrate can be used as the current collector. For example, fibrous, carbon-based substrates can be used as corrosion-resistant current collectors, such as carbon fiber paper (CFP), carbon fiber cloth (CFC), graphite fiber paper, and graphite fiber cloth. A carbon-based current collector can be adhered to a metal (e.g., Ni) tab using a conducting carbon-polymer composite adhesive, and the metal tab can be welded to electrical leads for charge and discharge. A pouch cell can be sealed with the metal tab extending outside the pouch with thermoplastic heat sealer between the tab and the pouch cell.

The current collectors, polymer binders, separators, electrolyte purification and battery fabrication processes developed in this disclosure are generally applicable to aluminum-ion batteries in general for various types of ionic liquid electrolytes, including urea and EMIC based electrolytes.

In some embodiments, the method further includes providing, between the anode and the cathode, a separator selected from a porous membrane, such as a glass fiber membrane, a regenerated cellulose membrane, a polyester membrane or a polyethersulfone membrane, or other hydrophobic membrane, such as polyethylene membrane, wherein the porous membrane is optionally coated with a hydrophilic polymer such as polyacrylic acid and polyvinyl alcohol, and which is cross-linked by heating.

In some embodiments, providing the ionic liquid electrolyte further includes vacuum pumping the ionic liquid electrolyte to further remove water and hydrochloric acid prior to vacuum sealing a battery stack in a container or pouch.

In some embodiments, the method further includes sealing a container or pouch with a carbon-based current collector glued to metal tabs extending outside the container or pouch for electrical wiring.

The electrolyte supports reversible deposition and dissolution (or stripping) of aluminum at the anode, and reversible intercalation and de-intercalation of anions at the cathode. The electrolyte can include an ionic liquid, which can support reversible redox reaction of a metal or a metal alloy included in the anode.

Higher coulombic efficiencies and longer cycle lives can be attained by reducing a content of any residual water, hydrochloric acid (HCl) and organic impurities in the electrolyte for various ionic liquid electrolytes for aluminum-ion batteries in general including EMIC, urea and other organic based ionic liquids. In some examples, a reduced content of residual water, HCl and organic impurities can be attained by subjecting the electrolyte, once formed, to a purification procedure. For example, to remove HCl in the electrolyte formed by residual water, HCl gas resulting from the residual water can be removed by subjecting the electrolyte to reduced pressure, such as under vacuum (e.g., about 0.1 Torr, about 10⁻² Torr, about 10⁻³ Torr, or less) for about 0.2 h to about 24 h or for about 0.5 h to about 24 h, until noticeable bubbling ceases. As another example, to remove HCl and organic impurities, one or more metal pieces (e.g., from an aluminum foil) can be added to the electrolyte, and, after agitation for a period of time, the electrolyte can be subjected to reduced pressure, such as under vacuum (e.g., about 0.1 Torr, about 10−2 Torr, about 10−3 Torr, or less) for about 0.2 h to about 24 h or for about 0.5 h to about 24 h. The battery, such as a pouch cell, including the anode, the cathode, the separator and the electrolyte can be assembled and subjected to vacuum again to remove any residual water and acids prior to sealing the battery.

During manufacturing, graphite particles (or other cathode active material) can be mixed or otherwise combined with a hydrophilic polymer binder along with a suitable solvent (e.g., water) to form a slurry, and the slurry can be coated or otherwise applied to form a cathode material on a current collector. For example, the cathode can be formed by making a slurry of a cathode active material, such as natural graphite particles, dispersed in a hydrophilic polymer binder solution in water, applying the slurry on the current collector, and annealing to a temperature between about 70° C. to about 250° C. in vacuum. In the case of a mixed polymer binder containing PAA and PVA, annealing crosslinks the two polymers to form an extended polymer binder network with high hydrophilicity and binding ability for active cathode materials.

### Methods of Using

The batteries described herein are useful for a variety of applications. In some of these applications, a high rate capacity battery is required. Some of these applications include grid-storage applications, uninterrupted power supply applications (e.g., power supply to computer server farms), home back-up applications, portable devices, and transportation.

Some of the methods herein include vacuum-pumping in combination with electrochemical cycling. In some applications, when a battery is deployed for use in a particular application, the battery may be monitored by, for example, a battery management system (BMS). If the BMS determines that the battery might benefit from additional vacuum-pumping, then a method of vacuum-pumping in combination with electrochemical cycling may be employed while the battery is deployed in an application. Such a method can removes corrosive reaction products which may have accumulated during battery cycling.

In some examples, including any of the foregoing, the methods include monitoring at least one metric selected from current density, voltage, impedance, pressure, temperature and capacity in order to determining if the battery might benefit from additional vacuum-pumping. In some examples, including any of the foregoing, the methods include monitoring current density. In some examples, including any of the foregoing, the methods include monitoring voltage. In some examples, including any of the foregoing, the methods include monitoring impedance. In some examples, including any of the foregoing, the methods include monitoring pressure. In some examples, including any of the foregoing, the methods include monitoring temperature. In some examples, including any of the foregoing, the methods include monitoring capacity.

In the methods described herein the electrochemical cells may be stacked in series or in parallel.

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### EXAMPLES

The Examples herein show how to make and use highly stable Al-ion batteries having an Al-metal anode. In some examples, by using fluorinated materials, e.g., FEP or PTFE, to pack or enclose the battery components, either in a pouch cell or hard container, harmful side reactions between electrolyte and the pouch or container material are minimized or avoided entirely. The Examples herein show that the fluorinated materials are stable during operation of the battery and also that they tolerant a highly acidic electrolyte environment even after long storage times. In some examples, a tube was inserted in the pouch cell enclosing the battery components to provide a conduit for removing by vacuum-pumping water and HCl, which was residually present in the battery's ionic liquid electrolyte as a consequence of its manufacturing, storage or use. The Examples herein show that continuous vacuum-pumping during charge-discharge cycling was important for making highly stable batteries which do not show capacity or CE decay (i.e., fade) as a function of charge-discharge cycle number when electrochemically cycled.

Unless stated otherwise to the contrary, the batteries in this example included an Al foil (Zhongzhoulvye Co., Ltd., 0.016-0.125 mm) metal anode. A 3-mm-wide and 0.09-mm-thick nickel tab (MTI, EQ-PLiB-NTA3) was bonded to the battery cathode comprised of natural graphite flake (GP) (Ted Pella, 61-302 SP-1 natural flake) mixed with a sodium alginate binder (Sigma) dried on a carbon fiber paper (CFP) (Mitsubishi, 30 g/m²) as the cathode current collector. Loading of graphite is ˜9-10 mg/cm². SiO₂ glass fiber filter paper (Whatman GF/A) was used as a separator. Aluminum electrodes were washed with acetone and gently scrubbed with a Kimwipes before use.

All electrolytes were made and batteries assembled in an Argon-filled glovebox with less than about 5 ppm water and oxygen in the glovebox. Aluminum Chloride (AlCl₃) (Alfa Aesar, anhydrous 99.9%) was used as received and opened inside the glovebox. 1-ethyl-3-methylimidazolium chloride, urea, and methylurea were vacuum dried at 60-90° C. for 24 hours.

Unless stated otherwise to the contrary, battery cathodes were prepared by depositing a graphite slurry onto a substrate, such as carbon fiber paper (CFP) or a Ni or a W mesh or foil. Graphite was mixed with sodium alginate in a graphite:alginate mass ratio of 95:5. Specifically, 950 mg GP, 50 mg sodium alginate binder, and 2-3 mL distilled water was used as the slurry. After stirring overnight, 5 mg of the slurry per cm² of the cathode substrate (−7.5 mg total) was loaded onto the cathode substrate (CFP), and the electrode was baked at 80° C. under vacuum overnight. For construction of the pouch cell, a Ni tab was used as a current collector, which was heat-sealed to attach it.

Unless specified to the contrary, all battery components inside a pouch were fixed in place using carbon tape, which was exposed to the electrolyte. The carbon tape was used to secure certain parts of the battery. However, the carbon tapes is not a necessary component and does not need to be present. A partially assembled cell was dried overnight at 80° C. under vacuum and transferred to the glovebox. In the glovebox, two layers of glass fiber filter paper separator (previously dried at 250° C.) and 1.5 g a 1.4:1 mole ratio of an AlCl₃ urea ionic liquid electrolyte were combined.

### Electrolyte Purification—Generally

Prior to injection into an electrochemical cell or battery assembly, hydrochloric acid (HCl) and water were removed from electrolyte mixtures prepared herein. The mixtures were heated (25-90° C.) and placed under vacuum-pumping (about 10-3 Torr) until noticeable bubbling from the mixture ceased.

To remove organic impurities, aluminum foil (Alfa Aesar, 99%) was added to an electrolyte after removing the Al foil's surface oxide layer using sand paper. After stirring overnight, the electrolyte was placed under vacuum at 25-90° C. once more before injecting the electrolyte into the battery. The electrolyte mixture was a clear liquid following this procedure.

### Electrochemical Analysis—Generally

Galvanostatic charge/discharge measurements were performed outside of the glovebox (Vigor Tech). Cyclic voltammetry (CV) measurements were executed on a potentiostat/galvanostat model CHI 760D (CH Instruments) or on a potentiostat/galvanostat model VMP3 (Bio-Logic) in both three-electrode and two-electrode modes. Unless specific to the contrary, discharge/charge cycling was performed at cell voltages of, e.g., 2.4 to 1 V and at 100 mAh/g current density on a Battery testing instrument (Neware). The working electrode was an aluminum foil or a GF, the auxiliary electrode included a platinum foil, and an Al foil was used as the reference electrode. All three electrodes were sealed in an enclosure containing AlCl3:[EMIm]Cl having a mole ratio of about 1.5:1 or 1.7:1 unless specified otherwise. CV measurements were carried out in the laboratory at the ambient environment. The scanning range was set from −1 to 0.85 V (vs. Al) for the Al anode and 0 to 2.5 V (vs. Al) for the graphite cathode, and the scan rate was 10 mV s⁻¹.

Instruments for electrochemical analysis were CHI 760D (CH Instruments), VMP3 (Bio-Logic) and Battery testing instrument (Neware).

### Example 1—Assembly

An Al-ion battery assembly was prepared. The battery included the following components. An Al metal anode having dimensions of approximately 4 cm²; a ˜6.25 cm² SiO₂ separator from Whatman (GF/A); a ˜2.25 cm² Ni foil coated with graphite (loading: ˜5 mg/cm²) for the cathode; and an 1.5-2.0 g ionic liquid electrolyte. A battery cell, consisting of Al foils (negative), graphite coated Ni foils (positive) and glass fiber separators, was orderly stacked and cathode and anode electrode current collectors were tab welded, respectively, using Ni tab and Al tab. The Al-ion battery was hot-sealed in a FEP pouch made of a single layer of FEP. The FEP pouch was hot-sealed using an impulse-sealer. The FEP pouch initially had one side open to allow for insertion of a gas valve. Optionally, the FEP layer was stacked with a polyimide layer prior to hot-sealing with the impulse sealer.

A second battery cell, consisting of Al foils (negative), graphite coated Ni foils (positive) and glass fiber separators, was orderly stacked and cathode and anode electrode current collectors were tab welded, respectively, using Ni tab and Al tab. The Al-ion battery was hot-sealed in a FEP pouch made of a layer of FEP and a layer of polyimide (PI). The FEP/PI pouch was hot-sealed using an impulse-sealer. The FEP/PI pouch initially had one side open to allow for insertion of a gas valve.

A third battery cell, consisting of Al foils (negative), graphite coated Ni foils (positive) and glass fiber separators, was orderly stacked and cathode and anode electrode current collectors were tab welded, respectively, using Ni tab and Al tab. The Al-ion battery was hot-sealed in a FEP pouch made of a layer of FEP and a layer of polyimide (PI). The FEP/PI pouch was hot-sealed using an impulse-sealer. The FEP/PI pouch initially had one side open to allow for insertion of a gas valve. The sealed FEP/PI pouch was then placed in an Al outer container.

The Al-battery pouch was transferred into an inert atmosphere electrolyte injection. AlCl₃ and organic cation chloride anion or AlCl₃-urea or AlCl₃-amide based ionic liquid or deep eutectic solvent electrolyte was injected. After enough electrolyte was injected, the bottom of the pouch was hot-sealed.

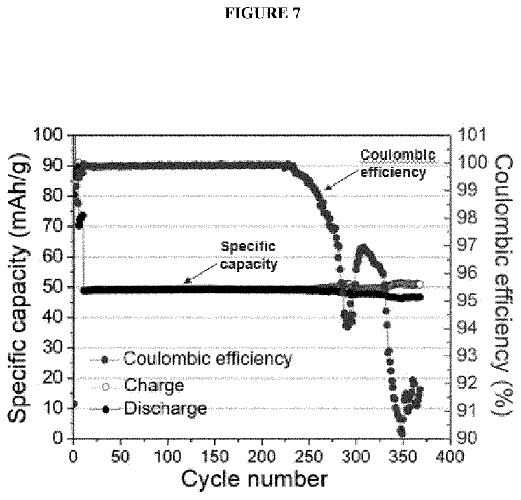

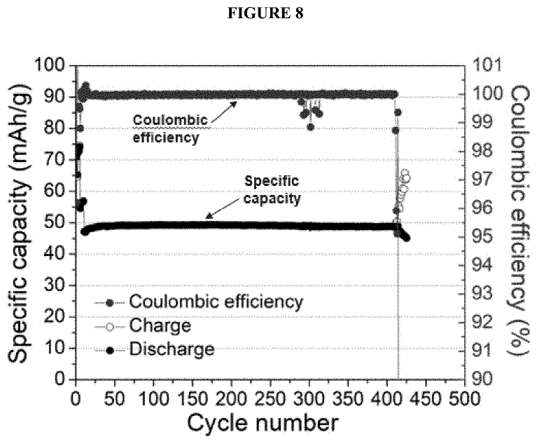

After an electrochemical activation process for the Al-ion battery, vacuum was used to remove gas and excessive electrolyte through the Teflon gas valve. A second hot-seal process was performed to finish the seal of the FEP or FEP/polyimide pouch. The data for the battery life cycle is shown in FIGS. 7 and 8.

Water (4.32 g/m²*24 h) and Oxygen (0.76 cm³/m²*24 h) can penetrate PI(100 μm)/FEP(30 μm) film to damage the AlCl₃-based ionic liquid electrolytes. A series of sealed pouches with battery cells was placed into an aluminum box with a top Al cover in a glovebox in an inert atmosphere. The aluminum box and top Al cover are then sealed by laser beam welding to prevent the stacked battery pouches inside from contacting water or oxygen in the air

### Example 2—Continuous Pumping and Cycling

The batteries in Example 1 were vacuum-pumped continuously through a tube which extended through and was sealed to the FEP pouch while cycling. The outer container, when used, was pumped to maintain a vacuum in the outer container, and the vacuum formed a negative pressure gradient across a wall of the inner container. The outer container was then sealed. Pumping the battery during its operation could remove the trace amount of water, which would react with electrolyte and forms HCl. Furthermore, the pumping while cycling also removes the products from side reactions which prevents further side reactions. Batteries with continuous vacuum-pumping for 30-60 cycles demonstrated almost no decay in performance, in terms of capacity or CE, after thousands of cycles.

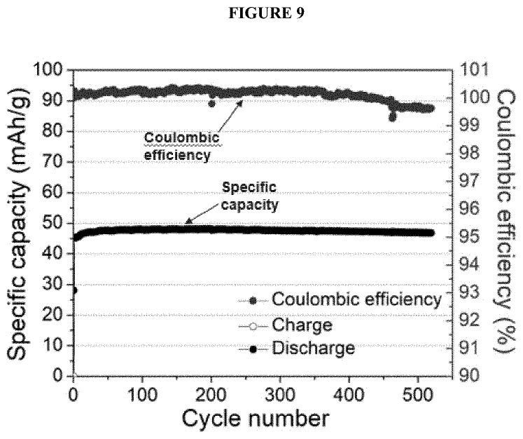

The battery was cycled at 1.0-2.3V voltage window with 100 mA/g current density at room temperature (−25° C.) using an ionic liquid electrolyte AlCl₃/EMIC having a molar ratio 1.4. The graphite loading in the cathode was 9-10 mg/cm². FIG. 7, FIG. 8 and FIG. 9 show the results from testing of the batteries.

FIG. 7 shows the cycle-life performance of a battery prepared as described above, and having an FEP pouch as inner container. The specific capacity and coulombic efficiency were stable up to about 220 charge discharge cycles.

FIG. 8 shows the cycle-life performance of a battery prepared as described above, and having an FEP pouch with an outer polyimide layer as the inner container. The specific capacity and coulombic efficiency were substantially stable up to about 400 charge discharge cycles. FIG. 8 shows an improvement in comparison to FIG. 7.

FIG. 9 shows the cycle-life performance of a battery prepared as described above, and having an FEP pouch with an polyimide layer as inner container and an Al outer container. The specific capacity and coulombic efficiency were substantially stable up to about 400 charge discharge cycles.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1. A battery assembly comprising:
at least one battery cell;
an inner container;
a compression apparatus for compressing the inner container; and
an outer container containing the inner container and the compression apparatus;
wherein:
the battery cell comprises a negative electrode, a positive electrode, and a non-aqueous electrolyte;
the inner container contains the non-aqueous electrolyte and the at least one battery cell;
the compression apparatus comprises:
a top soft plate and a bottom soft plate positioned on opposite sides of the inner container;
a top hard plate and a bottom hard plate positioned on opposite sides of the inner container;
wherein the top soft plate is between the top hard plate and the inner container; and
wherein the bottom soft plate is between the bottom hard plate and the inner container; and
the outer container comprises an outlet and a seal at the outlet, wherein the seal is configured to allow removal of gas from within the outer container.

2. The battery assembly of claim 1, comprising a means for compressing the top soft plate, bottom soft plate, top hard plate, and bottom hard plate.

3. (canceled)

4. The battery assembly of claim 1, wherein the inner container does not react with the non-aqueous electrolyte, and wherein the non-aqueous electrolyte is selected from an ionic liquid electrolyte (ILE) or a deep eutectic solvent electrolyte (DES).

5. The battery assembly of claim 1, wherein the inner container which contains the non-aqueous electrolyte comprises a fluorinated polymer, wherein the inner container further comprises a polyimide polymer layer in contact with the fluorinated polymer.

6-14. (canceled)

15. The battery assembly of claim 5, wherein the fluorinated polymer is selected from polytetrafluoroethylene (PTFE), fluorinated ethylene propylene (FEP), polyacrylonitrile (PAN), polychlorotrifluoroethylene (PCTFE), polyvinylidene fluoride (PVDF), hexafluoropropylene (HFP), PVDF-HFP, polyfluoroalkoxy (PFA), and combinations thereof.

16. (canceled)

17. The battery assembly of claim 1, wherein the inner container is a fluorinated ethylene propylene polymer pouch.

18. (canceled)

19. (canceled)

20. The battery assembly of claim 2, wherein the means for applying compression comprise at least one screw and at least one nut, wherein the at least one screw is positioned through the top hard plate and bottom hard plate.

21. (canceled)

22. The battery assembly of claim 1, wherein the at least one battery cell comprises an aluminum (Al) foil negative electrode, a graphite-coated nickel positive electrode and a glass fiber separator.

23-28. (canceled)

29. The battery assembly of claim 1, wherein the outer container is an aluminum (Al) container, a stainless steel container, or an engineered plastic container.

30-35. (canceled)

36. The battery assembly of claim 1, wherein the nonaqueous electrolyte is an ionic liquid electrolyte or a deep eutectic solvent electrolyte.

37. The battery assembly of claim 1, wherein the at least one battery cell comprises a metal negative electrode selected from a lithium metal negative electrode, an aluminum metal negative electrode, a sodium metal negative electrode, a potassium metal negative electrode, a calcium metal negative electrode, a magnesium metal negative electrode, an iron metal negative electrode, and a zinc metal negative electrode.

38-42. (canceled)

43. The battery assembly of claim 1, wherein the outer container is configured to maintain a vacuum in the outer container, and the vacuum forms a negative pressure gradient across a wall of the inner container.

44. The battery assembly of claim 1, wherein the outer container is configured to maintain an inert gas environment in the outer container, and the vacuum forms a negative pressure gradient across a wall of the inner container.

45. (canceled)

46. (canceled)

47. The battery assembly of claim 1, wherein the outer container has less than 100 ppm H₂O inside the outer container and less than 100 ppm O₂ inside the outer container.

48-50. (canceled)

51. The battery assembly of claim 1, wherein the at least one battery cell comprises a composite separator, comprising a glass fiber layer; a fluorinated polymer layer, or a derivative thereof; and optionally a binder.

52-72. (canceled)

73. The battery assembly of claim 1, wherein the non-aqueous electrolyte comprises a member selected from the group consisting of alkylimidazolium aluminates, alkylpyridinium aluminates, alkylfluoropyrazolium aluminates, alkyltriazolium aluminates, aralkylammonium aluminates, alkylalkoxyammonium aluminates, aralkylphosphonium aluminates, aralkylsulfonium aluminates, alkylguanidinium aluminates, and combinations thereof.

74-84. (canceled)

85. A method for assembling a battery, the method comprising:
placing a battery cell and an electrolyte into an inner container;
vacuum sealing the inner container after the battery cell and the electrolyte are placed into the inner container to form a sealed inner container;
placing a second battery cell and a second electrolyte into a second inner container;
vacuum sealing the second inner container after the second battery cell and the second electrolyte are placed into the second inner container to form a second sealed inner container;
placing the sealed inner container and sealed second inner container inside an outer container;
sealing the outer container; and
creating a vacuum or inert environment in the outer container while the inner container is encased inside the outer container, the vacuum, when present, forming a pressure gradient between a region outside of the inner container and a region inside of the inner container.

86-90. (canceled)

91. A method for assembling a battery, the method comprising:
placing a battery cell and an electrolyte into an inner container;
vacuum sealing the inner container after the battery cell and the electrolyte are placed into the inner container;
after sealing of the inner container, cycling the battery;
optionally after or while cycling the battery, removing the gas from within the inner container;
placing the sealed inner container inside an outer container;
sealing the outer container; and
creating a vacuum or inert environment in the outer container while the inner container is encased inside the outer container, the vacuum, when present, forming a pressure gradient between a region outside of the inner container and a region inside of the inner container.

92-99. (canceled)

100. The battery assembly of claim 51, wherein the fluorinated polymer is selected from polytetrafluoroethylene (PTFE), fluorinated ethylene propylene (FEP), polyacrylonitrile (PAN), polychlorotrifluoroethylene (PCTFE), polyvinylidene fluoride (PVDF), hexafluoropropylene (HFP), PVDF-HFP, polyfluoroalkoxy (PFA), and combinations thereof.
